(19) United States
(12) Patent Application Publication
(10) Pub. No.: US 2026/0006089 A1
(43) Pub. Date: Jan. 1, 2026

(54) OPTIMIZED DELIVERY FOR SPHERICAL MEDIA CONTENT

(71) Applicant: Adeia Guides Inc., San Jose, CA (US)

(72) Inventors: Christopher Phillips, Hartwell, GA (US); Dhananjay Lal, Englewood, CO (US)

(21) Appl. No.: 18/756,341

(22) Filed: Jun. 27, 2024

(51) Int. Cl. H04L 65/752; H04L 65/80

(52) U.S. Cl. CPC H04L 65/752; H04L 65/80

(57) ABSTRACT

Systems and methods are provided for receiving, from a computing device and over a network, a request to access a spherical media content comprising tiles. One or more portion(s) of the spherical media content likely to be included in a viewport of the computing device are determined, and video qualities for the tiles are determined based on such one or more portion(s). One or more tiles corresponding to the one or more portions likely to be included in the viewport are selected to be provided to the computing device in higher video qualities of the plurality of video qualities than tiles of the plurality of tiles not likely to be included in the viewport. Based on the video qualities, urgency parameters for tiles of the spherical media content are identified, and based on the urgency parameters, the tiles are transmitted over the network to the computing device.

### CROSS-REFERENCE TO RELATED APPLICATIONS

The disclosure of commonly owned application Ser. No. 18/626,668, filed Apr. 4, 2024, and entitled “CUSTOMER-CENTRIC, APPLICATION-FLOW AWARE BROADBAND SERVICE,” (Attorney docket no. 003597-2998-101) is hereby incorporated by reference herein in its entirety. The disclosure of commonly owned application Ser. No. 18/626,659, filed Apr. 4, 2024, and entitled “APPLICATION FLOW-AWARE BROADBAND SERVICE WITH DATA CAPS,” (Attorney docket no. 003597-4007-101) is hereby incorporated by reference herein in its entirety. The disclosure of commonly owned application Ser. No. 18/667,655, filed May 17, 2024, and entitled “INTELLIGENT APPLICATION PRIORITY PACKET DELIVERY CONTROL,” (Attorney docket no. 003597-4018-101) is hereby incorporated by reference herein in its entirety. The disclosure of commonly owned application Ser. No. 18/744,496, filed Jun. 14, 2024, and entitled “DYNAMIC SYSTEMS AND METHODS FOR MEDIA-AWARE LOW-TO ULTRALOW-LATENCY, REAL-TIME TRANSPORT PROTOCOL CONTENT DELIVERY,” (Attorney docket no. 003597-4029-101) is hereby incorporated by reference herein in its entirety. The disclosure of commonly owned application Ser. No. 18/744,547, filed Jun. 14, 2024, and entitled “DYNAMIC SYSTEMS AND METHODS FOR MEDIA-AWARE TRANSPORT OF FRAGMENT OF CONTENT IN LOW-LATENCY, OVER-THE-TOP, AND ADAPTIVE BITRATE STREAMING,” (Attorney docket no. 003597-4033-101) is hereby incorporated by reference herein in its entirety. The disclosure of commonly owned application Ser. No. 18/756,163, filed Jun. 27, 2024, and entitled “NETWORK-ASSISTED DELIVERY OF HTTP TRANSPORT,” (Attorney docket no. 003597-4039-101) is hereby incorporated by reference herein in its entirety.

### BACKGROUND

This disclosure is directed to systems and methods for using priority parameters in transmitting and/or receiving tiles of spherical media content.

### SUMMARY

The proliferation of cameras with multiple lenses that enable users to record video in multiple vantage points at the same time has enabled media content to be created and consumed in ways that differ from traditional video cameras with a single lens. For example, such cameras enable users to record 180-degree or 360-degree videos. These cameras may be used to create monoscopic or stereoscopic content (i.e., with the same picture being delivered to the screens of a virtual reality (VR) headset or with different pictures being delivered to the screens of a VR headset). A VR headset is typically worn on a user's head and receives content in ultra-high resolutions and frame rates. The media content item resulting from a recording via the camera, for example, an omnidirectional, panoramic or spherical media content item, can be uploaded to a video sharing platform, such as YouTube, and users can stream the spherical media content item to a computing device, such as a laptop or a VR headset. In the example of the laptop, the video is flattened, and the user may use, for example, a mouse to move the output of the spherical content item. In the example of the VR headset, as a user moves their head, the VR headset will generate and display different portions of the spherical media content item to the user. The portion of the spherical media content that is displayed to the user may be known as a viewport. As the user moves around the spherical media content, for example, via a mouse or via moving their head, the viewport changes.

Various methods may be utilized in order to reduce the amount of bandwidth and/or processing power that is required to stream spherical media content items. One example method is that of projecting an equirectangular frame and grid onto the spherical content item, wherein only a subset of the squares/rectangles (i.e., tiles) formed by the grid is sent to the computing device at a full resolution. The subset of tiles can be dictated by the viewport, for example, only the tiles that are displayed to the user are streamed in full resolution. In some example systems, the tiles are streamed to the computing device via an HTTP-based solution for adaptive bitrate streaming, such as via the dynamic adaptive streaming over HTTP (DASH) standard that responds to user device and network conditions. In another example, the tiles immediately surrounding the viewport may be streamed in a lower resolution, and the other tiles may not be streamed at all. While such methods are useful, given the growth in popularity of spherical media content items, there is a need for better utilization of computing resources, such as bandwidth and/or processing power, when providing spherical media content items over a network to a client device.

To help address these needs, systems and methods are provided for receiving, from a computing device and over a network, a request to access a spherical media content comprising a plurality of tiles, and determining one or more portions of the spherical media content likely to be included in a viewport associated with the computing device. The disclosed systems and methods may further be configured to determine, based at least in part on the determined one or more portions of the spherical media content likely to be included in the viewport, a plurality of video qualities for the plurality of tiles, wherein one or more tiles of the plurality of tiles corresponding to the one or more portions of the spherical media content likely to be included in the viewport are selected to be provided to the computing device in higher video qualities of the plurality of video qualities than tiles of the plurality of tiles not likely to be included in the viewport. The disclosed systems and methods may further be configured to, based at least in part on the plurality of video qualities, identify a plurality of urgency parameters for the plurality of tiles, and, based at least in part on the identified plurality of urgency parameters, transmit the plurality of tiles over the network to the computing device.

Such aspects may enable leveraging one or more priority parameters (e.g., HTTP urgency parameters) for the optimized delivery of tiles, e.g., included in 360-degree video tile-based streams employing DASH Spatial Representation Description (SRD) media presentation descriptions (MPDs). For example, the disclosed systems and methods may employ foveated rendering in conjunction with the one or more priority parameters for the optimized delivery of the tiles based on user's gaze within their field of view (FOV) (e.g., within the viewport of an extended reality device being worn or used by the user). In some embodiments, such delivery may be further based at least in part on current network conditions (e.g., bandwidth). For example, when mapping tile priority values based on field of vision considering estimated bandwidth, an additional urgency value (e.g., that qualifies the user's gaze within their FOV) may be calculated and used as a parameter in an HTTP/3 request when requesting a tile. Based on the content and the urgency values, preferential network traffic techniques (e.g., Low Latency, Low Loss, and Scalable Throughput (L4S)) may be enabled or disabled when delivering the selected tiles from a content delivery network (CDN) edge node to a client device.

In some embodiments, networking equipment associated with the network provides a first queue for preferential network traffic and a second queue for non-preferential network traffic, and transmitting the plurality of tiles over the network to the computing device based at least in part on the identified plurality of urgency parameters comprises transmitting a first subset of the plurality of tiles using the first queue and transmitting a second subset of the plurality of tiles using the second queue.

In some embodiments, the first subset of the plurality of tiles are transmitted using the first queue based at least in part on having urgency parameter values that exceed a threshold value, and the second subset of the plurality of tiles are transmitted using the second queue based at least in part on having urgency parameter values that do not exceed the threshold value. In some embodiments, the first subset of the plurality of tiles are transmitted prior to transmitting the second subset of the plurality of tiles.

In some embodiments, the disclosed systems and methods may be configured to, for each respective urgency level of the plurality of urgency levels: determine whether tiles of the respective urgency level are associated with an incremental parameter; transmit tiles of the respective urgency level associated with the incremental parameter serially in their entirety; and transmit tiles of the respective urgency level not associated with the incremental parameter in parallel.

In some embodiments, a manifest is provided to the computing device, and the plurality of video qualities and the plurality of urgency parameters are determined based on one or more indications received from the computing device, wherein the computing device uses the manifest to identify the plurality of video qualities.

In some embodiments, the plurality of video qualities comprises a plurality of bitrates and resolutions, and the plurality of video qualities are determined based at least in part on current network conditions.

In some embodiments, determining the one or more tiles of the plurality of tiles likely to be included in the viewport associated with the computing device comprises: determining at least one of a gaze or a head pose of a user of the computing device; and determining the one or more tiles of the plurality of tiles likely to be included in the viewport associated with the computing device based on determining that the gaze and/or the head pose of the user corresponds to one or more locations of the one or more tiles. In some embodiments, head pose may be used to determined the FOV, and gaze may be used to determine the foveation region within the FOV, each of which together may be used to determine urgency for each tile.

In some embodiments, the computing device determines, for each respective tile of the plurality of tiles, an indication of a likelihood that the gaze or the head pose of the user will correspond to the location of the respective tile, wherein the plurality of video qualities are indicated on a manifest provided to the computing device, and wherein a video quality of the plurality of video qualities that each respective tile is to be provided to the computing device in is based on its corresponding determined likelihood. In some embodiments, identifying the plurality of urgency parameters for the plurality of tiles is based on receiving indications of the plurality of urgency parameters from the computing device, wherein the computing device assigns the plurality of urgency parameters for the plurality of tiles based on the plurality of video qualities. For example, head pose may be used to determine FOV of the user, and gaze may be used to determine foveation within the FOV (e.g., foveation may be determined based on head pose and gaze in combination)

In some embodiments, the plurality of urgency parameters are HTTP urgency parameters for retrieving an HTML document or an XML document.

In some embodiments, a server determines the one or more portions of the spherical media content likely to be included in the viewport, the plurality of video qualities for the plurality of tiles, and the plurality of urgency parameters for the plurality of tiles, based at least in part on one or more indications received from the computing device.

### BRIEF DESCRIPTION OF THE DRAWINGS

The present disclosure, in accordance with one or more various embodiments, is described in detail with reference to the following figures. The drawings are provided for purposes of illustration only and merely depict typical or example embodiments. These drawings are provided to facilitate an understanding of the concepts disclosed herein and should not be considered limiting of the breadth, scope, or applicability of these concepts. It should be noted that for clarity and ease of illustration, these drawings are not necessarily made to scale.

FIG. 1 shows an illustrative architecture for a system for processing network traffic, in accordance with some embodiments of this disclosure.

FIGS. 2A-2B show illustrative block diagrams for providing a dual-queue service configuration, in accordance with some embodiments of this disclosure.

FIG. 3 shows an illustrative diagram of network traffic in a system, in accordance with some embodiments of this disclosure.

FIG. 4 shows illustrative marking of explicit congestion notification (ECN) bits, in accordance with some embodiments of this disclosure.

FIG. 5 shows illustrative spherical media content, in accordance with some embodiments of this disclosure.

FIG. 6 shows a flowchart of an illustrative process for treating portions of a network resource preferentially, in accordance with some embodiments of this disclosure.

FIG. 7 shows an illustrative block diagram showing functions performed by various layers in the networking stack of a sender, in accordance with some embodiments of this disclosure.

FIGS. 8A-8B show illustrative examples for different tiling schemes for a cube map projection, in accordance with some embodiments of this disclosure.

FIG. 9 shows an illustrative example of a tiled encoding system for both live 360-degree content and VOD 360-degree content, in accordance with some embodiments of this disclosure.

FIG. 10 shows an illustrative example for tiled media delivery using an HTTP/3 QUIC delivery server, in accordance with some embodiments of this disclosure.

FIG. 11 shows an illustrative flowchart for a client device method for the optimized tile selection and delivery for DASH SRD 360-degree content for foveated rendering, in accordance with some embodiments of this disclosure.

FIG. 12 shows an illustrative flowchart for a CDN edge node delivery method for optimized tile selection and delivery for DASH SRD 360-degree content for foveated rendering leveraging L4S, in accordance with some embodiments of this disclosure.

FIGS. 13-14 show illustrative devices and systems for using priority parameters in transmitting and/or receiving tiles of spherical media content, in accordance with some embodiments of this disclosure.

FIG. 15 is a flowchart of a detailed illustrative process for using priority parameters in receiving and/or transmitting tiles of spherical media content, in accordance with some embodiments of this disclosure.

### DETAILED DESCRIPTION

Throughout the specification the phrases “in response to” and “based on” shall be understood to have a broad meaning unless context requires otherwise. For example, “in response to” can refer to a step that is in direct or indirect response to a prior step, and “based on” can refer to a step that is based at least in part on a prior step.

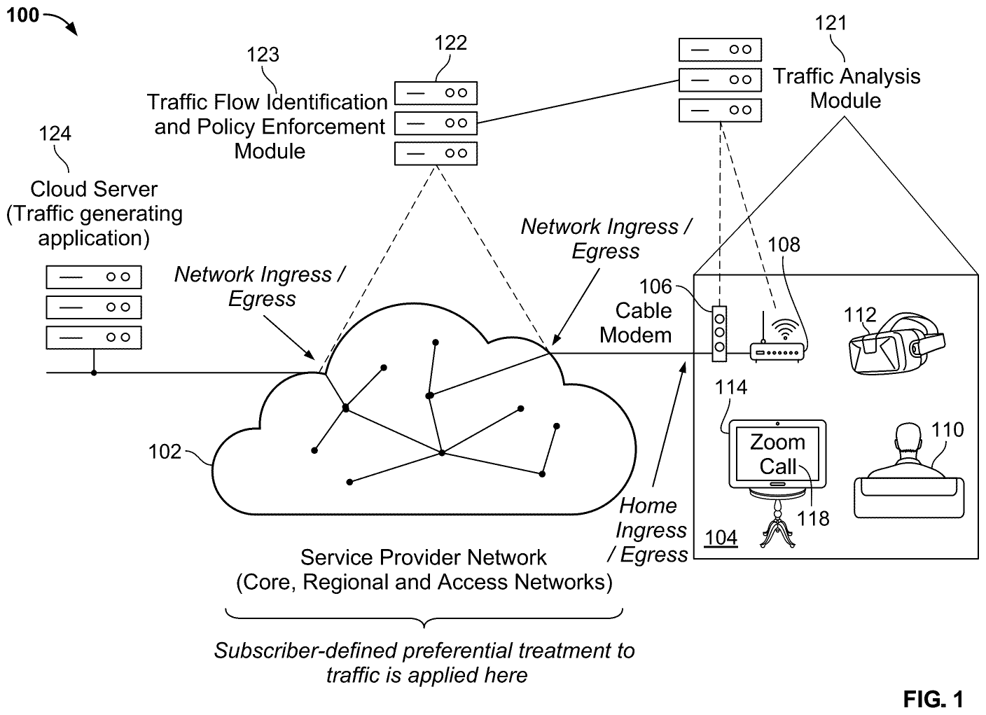

FIG. 1 shows an illustrative architecture for processing network traffic, in accordance with some embodiments of this disclosure. System 100 may comprise service provider network 102, physical location 104 (e.g., a home of user 110, a place of business, a school, or any other suitable location, or any combination thereof), networking equipment 106 and 108 (e.g., a modem, router, switch, gateway, wireless access point, mesh access point, extender, hub, and/or any other suitable networking equipment), devices 112 and 114, and/or any other suitable components. In some embodiments, modem 106, router 107 and/or networking equipment 122 may comprise a traffic analysis module 121 and/or a traffic flow identification and policy enforcement module (TIPE) module 123. In some embodiments, cloud server 124 comprises a traffic generating application 125. System 100 may comprise any suitable combination of hardware and/or software to provide the functionalities described herein.

Service provider network 102 may include, for example, any suitable software and/or hardware (e.g., networking equipment, servers, and/or databases) and/or any suitable infrastructure (e.g., physical cable transmission lines, fiber-optic transmission channels or mediums or channels, satellites) to provide core, regional, access networks and/or backhaul (and/or any other suitable portion of the network) of one or more Internet service providers (ISPs), to facilitate a telecommunications network. In some embodiments, the ISP may be provided by a business or other organization that provides access to the Internet for a fee. For example, service provider network 102 may correspond to or comprise a wide area network (WAN), to facilitate Internet connectivity (or connectivity over any other suitable public or private network) between networked devices worldwide or over any other suitable geographic region or location(s), to enable such devices to exchange information and resources. In some embodiments, a WAN or service provider network 102 may be used to connect LANs (and/or other types of communication) to enable electronic communications between remotely located devices. In the example of FIG. 1, the local area network (LAN), e.g., a small scale network for data exchange between a group of computers or other devices at a single location, provided at location 104 by way of networking equipment 106 and/or 108, may not be considered as part of the WAN provided by service provider network 102. Service provider network 102 may provide broadband, high bandwidth Internet access.

In some embodiments, networking equipment 122 and cloud server 124 may be located remote from location 104. The devices, servers, and networking equipment of system 100 may communicate over a wired connection and wireless connection. For example, devices 112, 114 and networking equipment 106 and 108 may be equipped with antennas for transmitting and receiving electromagnetic signals at frequencies within the electromagnetic spectrum, e.g., radio frequencies, to communicate with each other over a network in a localized area. The network within location 104 may correspond to, e.g., a wireless fidelity (Wi-Fi) network, such as, for example, 802.11n, 802.11ac, 802.11ax, Wi-Gig/802.11ad, 802.11 (Wi-Fi 7) at a fronthaul of a telecommunications network, to provide wireless networking technology allowing electronic devices to connect to one another and/or the Internet from a shared network access point.

The devices of system 100 may communicate over a wired LAN and/or may communicate wirelessly over a wireless LAN (WLAN) and to transmit data to and receive data from the Internet, and may be present within an effective coverage area of the localized network. The Internet is a global system of interconnected computer networks and devices employing common communication protocols, e.g., the transmission control protocol (TCP), user datagram protocol (UDP) and the Internet protocol (IP) in the TCP/IP or UDP/IP suite.

Router 108 may be configured to forward or route data packets from the Internet connection, received by way of modem 106, to devices within the localized network of system 100 and receive data packets from such devices. In some embodiments, router 108 may include a built-in modem to provide access to the Internet for the household (e.g., received by way of cable or fiber connections included in backhaul portions of a telecommunications network), built-in switches or hubs to deliver data packets to the appropriate devices within the Wi-Fi network, built-in access points to enable devices to wirelessly connect to the Wi-Fi network, and/or system 100 may include one or more stand-alone modems, switches, routers and access points. In some embodiments, modem 106 and/or router 108 may be leased from and/or installed at location 104 (e.g., the customer's premises) by the ISP as part of a managed Wi-Fi install, to give service provider network 102 visibility into LAN and WAN network traffic associated with data transmitted to or receive from modem 106 of location 104.

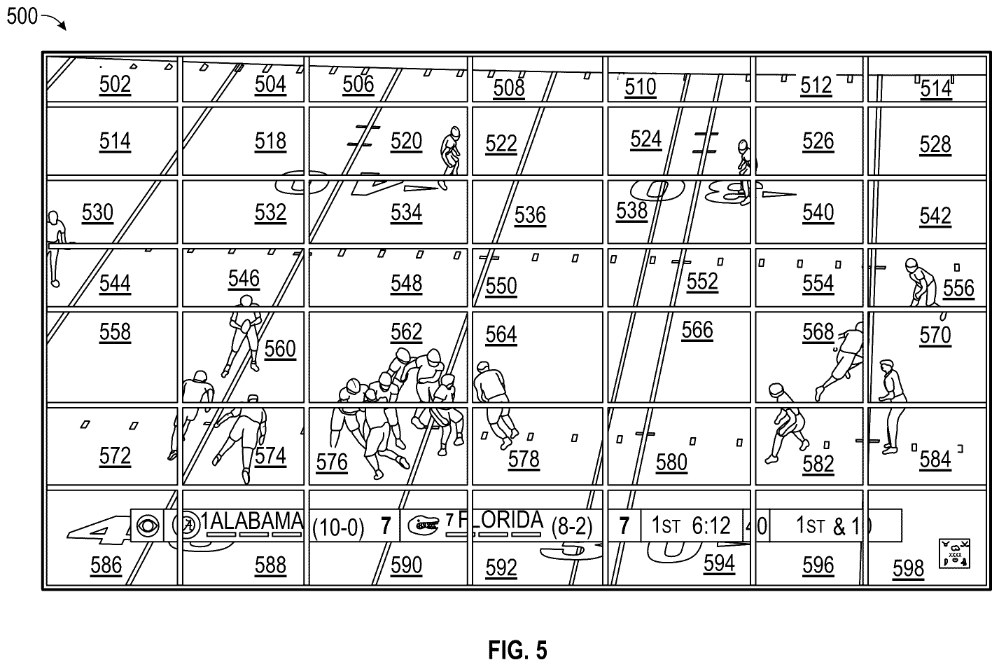

In some embodiments, one or more applications and/or media assets may be provided to user 110 by way of wired or wireless signals transmitted through the LAN at location 104. For example, user 110 may be provided spherical media content (e.g., a 360-degree video of a college football game, as shown in FIG. 5, and/or immersive content, XR content, or any suitable content, or any combination thereof) via XR device 112 and/or a video game console, each of which may be connected to the Internet via the LAN within location 104 to provide such content. As another example, tablet 114 may additionally or alternatively be connected to the Internet via the LAN to provide a video conferencing application (e.g., Zoom) 118 to user 110.

In some embodiments, devices 112 and 114 may be, for example a headset; a mobile device such as, for example, a smartphone or tablet; a laptop computer; a personal computer; a desktop computer; a smart television; a smart watch or wearable device; smart glasses; extended reality (XR) head-mounted display (HMD); a stereoscopic display; a wearable camera; XR glasses; XR goggles; a near-eye display device; a robot; an autonomous cleaning device; or any other suitable user equipment or device capable of connecting to the Internet or other suitable network; or any combination thereof. In some embodiments, traffic analysis module 121 and TIPE module 123 may be implemented in conjunction to achieve one of more of the functionalities described herein.

XR may be understood as virtual reality (VR), augmented reality (AR) or mixed reality (MR) technologies, or any suitable combination thereof. VR systems may project images to generate a three-dimensional environment to fully immerse (e.g., giving the user a sense of being in an environment) or partially immerse (e.g., giving the user the sense of looking at an environment) users in a three-dimensional, computer-generated environment. Such environment may include objects or items that the user can interact with. AR systems may provide a modified version of reality, such as enhanced or supplemental computer-generated images or information overlaid over real-world objects. MR systems may map interactive virtual objects to the real world, e.g., where virtual objects interact with the real world or the real world is otherwise connected to virtual objects.

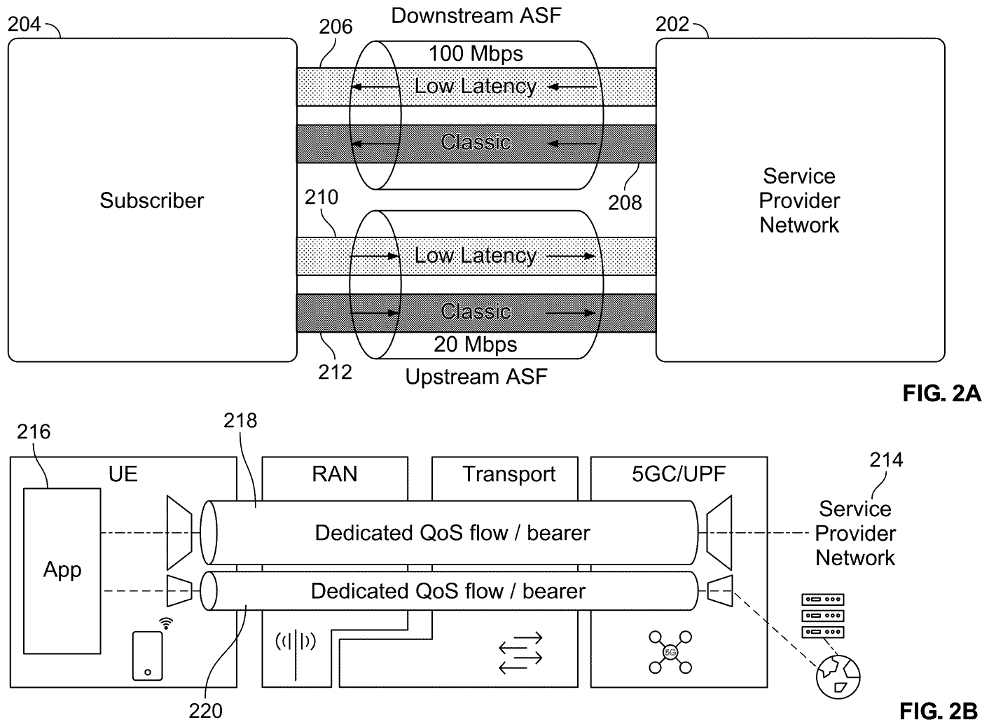

FIGS. 2A-2B show illustrative block diagrams for providing a dual-queue service configuration, in accordance with some embodiments of this disclosure. System 100 may provide (e.g., in the WAN) a queue for low latency (e.g., L4S) network traffic and a queue for classic traffic, based at least in part using networking equipment 122 of FIG. 1. For example, the low latency queue of system 100 may be associated with low latency service flow 206 and low latency service flow 210, and the classic queue of system 100 may be associated with classic queue of service flow 208 and 212, as discussed in more detail in as White et al., “Low Latency DOCSIS: Technology Overview,” Cable Labs, 2019 Fall Technical Forum SCTE-ISBE (hereinafter “White et al.), the contents of which are hereby incorporated by reference herein in their entirety. A downstream aggregate service flow (ASF) over service flow 206, 210 between subscriber 204 and service provider network 202 may include low latency service flow 206 and classic service flow 210, and an upstream ASF between subscriber 204 and service provider network 202 may include low latency service flow 210 and classic service flow 212. In some embodiments, networking equipment (e.g., modem 106 and/or router 108 and/or other networking equipment) may provide one or more buffers or other suitable memory at which the low latency queue and the classic queue may be stored. In some embodiments, system 100 may employ per-flow queues and/or per-flow AQMs, in addition to or in the alternative to dual-queuing.

In some embodiments, service provider network 202 may correspond to service provider network 102 of FIG. 1, networking equipment modem 106 and/or router 108, and subscriber 204 may correspond to networking equipment 106, 108 of user 110 at location 104 of FIG. 1. FIG. 2B may correspond to an architecture for a cellular network, and service provider network 214 which may correspond to service provider network 102 of FIG. 1, and client device or user equipment 216 may correspond to service provider network 102 of FIG. 1, networking equipment 122 and/or cloud server 124.

L4S provides an end-to-end solution to provide certain traffic flows, such as, for example, gaming or voice, with reduced latency. With L4S, the data source and/or data recipient may execute congestion control algorithms to efficiently utilize available capacity while minimizing latency and packet loss, where the data source may use congestion feedback received from the recipient to optimize data transmission. With LAS, the header of an IP packet may indicate, via an explicit congestion notification (ECN), whether the IP packet supports L4S and whether congestion is being experienced, e.g., marking specific packets as having queuing delay that exceeds a threshold. L4S may be implemented at the transport layer by the service provider network and/or application service providers at client and server. In some embodiments, L4S may be enabled by operating system (OS) providers, such as, for example, Google and Apple.

As stated in Internet Engineering Task Force (IETF), “Low Latency, Low Loss, and Scalable Throughput (L4S) Internet Service: Architecture,” RFC 9330 January 2023, (referred to herein as RFC 9330), the contents of which are hereby incorporated by reference herein in their entirety, “queuing remains a major, albeit intermittent, component of latency. For instance, spikes of hundreds of milliseconds are not uncommon, even with state-of-the-art Active Queue Management (AQM) . . . . It has been demonstrated that, once access network bit rates reach levels now common in the developed world, increasing link capacity offers diminishing returns if latency (delay) is not addressed.” RFC 9330 further states that “[q] ueuing delay degrades performance intermittently. . . . It occurs i) when a large enough capacity-seeking (e.g., TCP) flow is running alongside the user's traffic in the bottleneck link, which is typically in the access network, or ii) when the low latency application is itself a large capacity-seeking or adaptive rate flow (e.g., interactive video).”

As further stated in RFC 9330, “[t] his document describes the L4S architecture, which enables Internet applications to achieve low queuing latency, low congestion loss, and scalable throughput control. L4S is based on the insight that the root cause of queuing delay is in the capacity-seeking congestion controllers of senders, not in the queue itself. With the L4S architecture, all Internet applications could (but do not have to) transition away from congestion control algorithms that cause substantial queuing delay and instead adopt a new class of congestion controls that can seek capacity with very little queuing. These are aided by a modified form of Explicit Congestion Notification (ECN) from the network. With this new architecture, applications can have both low latency and high throughput. The architecture primarily concerns incremental deployment. It defines mechanisms that allow the new class of L4S congestion controls to coexist with ‘Classic’ congestion controls in a shared network. The aim is for L4S latency and throughput to be usually much better (and rarely worse) while typically not impacting Classic performance.”

As further stated in RFC 9330, “[t]he Dual-Queue Coupled AQM . . . acts like a ‘semi-permeable’ membrane that partitions latency but not bandwidth. As such, the two queues are for transitioning from Classic to L4S behaviour, not bandwidth prioritization.” RFC 9330 further states that “Two separate queues are used to isolate L4S queuing delay from the larger queue that Classic traffic needs to maintain full utilization” and “The two queues act as if they are a single pool of bandwidth in which flows of either type get roughly equal throughput without the scheduler needing to identify any flows.”

RFC 9330 further states that “the scheduler can serve the L4S queue with priority (denoted by the ‘1’ on the higher priority input), because the L4S traffic isn't offering up enough traffic to use all the priority that it is given. Therefore, for latency isolation on short timescales (sub-round-trip), the prioritization of the L4S queue protects its low latency by allowing bursts to dissipate quickly; but for bandwidth pooling on longer timescales (round-trip and longer), the Classic queue creates an equal and opposite pressure against the L4S traffic to ensure that neither has priority when it comes to bandwidth [symbol] the tension between prioritizing L4S and coupling the marking from the Classic AQM results in approximate per-flow fairness.”

As further stated in White et al., AQM can ensure that the Classic queue is not starved: “To enable the Low Latency Queue to rapidly dequeue an arrived burst of traffic, the Inter-Service-Flow scheduler gives a higher weight to the Low Latency Queue than it does to the Classic Queue. The coupling to the Low Latency AQM counterbalances the weighted scheduler by making low-latency applications leave space for Classic traffic. This ensures that the weighted scheduler does not give priority over bandwidth, as a traditional weighted scheduler would.” Further, as stated in Internet Engineering Task Force (IETF), “Dual-Queue Coupled Active Queue Management (AQM) for Low Latency, Low Loss, and Scalable Throughput (L4S),” RFC 9332 January 2023, (referred to herein as RFC 9332), the contents of which are hereby incorporated by reference herein in their entirety: “The scheduling weight of the Classic queue should be small (e.g., 1/16) . . . if L4S traffic is over-aggressive or unresponsive, the scheduler weight for Classic traffic will at least be large enough to ensure it does not starve in the short term” and “The scheduler draining the two queues MUST give L4S packets priority over Classic, although priority MUST be bounded in order not to starve Classic traffic” and “The L4S queue has latency priority within sub-round-trip timescales, but over longer periods the coupling from the Classic to the L4S AQM . . . ensures that it does not have bandwidth priority over the Classic queue.”

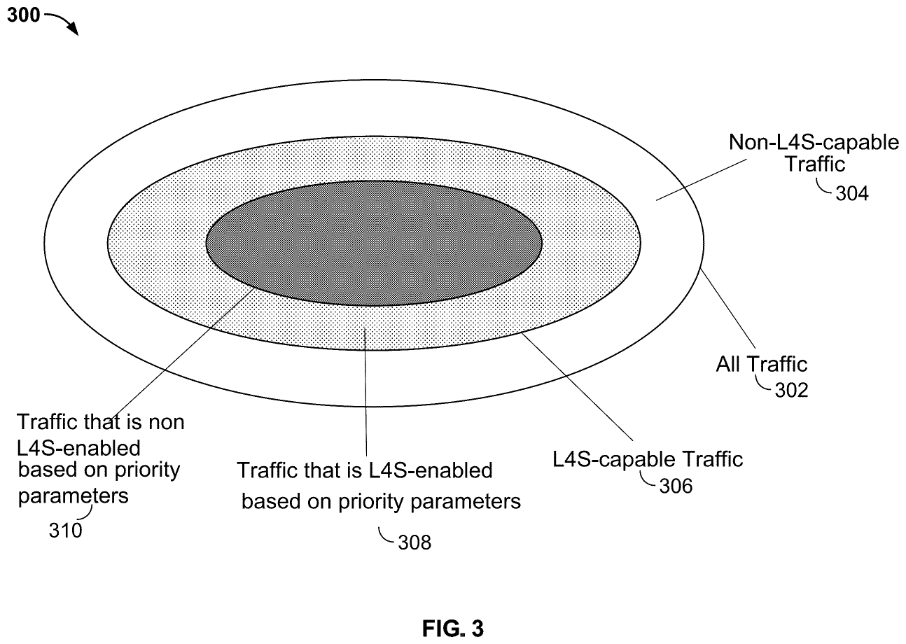

FIG. 3 shows an illustrative Venn diagram 300 of network traffic in system 100, in accordance with some embodiments of this disclosure. In some embodiments, system 100 may utilize the L4S standard, and/or any other suitable standard or techniques to treat certain portions of network traffic presently. As shown in FIG. 3, system 100 may categorize network traffic 302 as non-L4S-capable traffic 304 or L4S-capable traffic 306. L4S-capable traffic 306 may comprise traffic 308 that is LAS-enabled based on priority parameters, as discussed in more detail below, and traffic 310 that is not L4S-enabled based on priority parameters. In some embodiments, portions of a network resource that are not L4S-capable may be assigned priority parameters indicative of non-urgent and processed using the second queue for non-preferential network traffic.

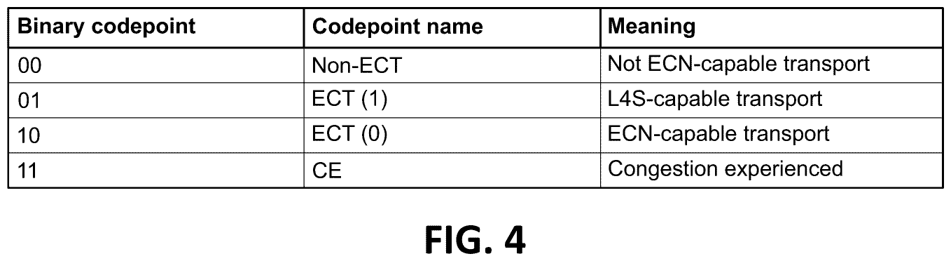

FIG. 4 shows illustrative marking of explicit congestion notification (ECN) bits, in accordance with some embodiments of this disclosure. In some embodiments, to determine whether a packet should be assigned to a low latency service flow (e.g., 206, 210, 218 of FIGS. 2A-2B), ISPs and application service providers of low latency traffic (e.g., cloud gaming) of system 100 may mark portions of their traffic with a codepoint, e.g., a differentiated services (DiffServ) codepoint or any other suitable codepoint. This codepoint indicates the ISP's and/or application service provider's ability to perform scalable congestion control, e.g., to respond to a congestion notification in a graceful manner that does not aggressively reduce throughput. For example, the ISP or application service provider may use the DiffServ field information (e.g., in the network packet IP header) to shift a packet to the low latency service flow in a “weakest link” of the network, such as, for example, the access network. In some embodiments, the ISP may signal congestion using an ECN field when appropriate, to produce a graceful degradation in throughput from the application service provider's server. In some embodiments, an ISP and/or application service provider may allow a customer to indicate that network traffic to a particular device and/or for a particular application, e.g., based on a particular service type associated with the application, should be provided with latency priority, e.g., assigned to the low latency service flow.

In some embodiments, ECN may be contained within the DiffServ codepoint to indicate whether or not congestion is experienced by marking the two least-significant bits in the DiffServ in the IP header identifying a data packet. For example, the most significant six bits in the DiffServ field may contain the differentiated services code point (DSCP) bits, and the state of the two ECN bits indicates whether or not the packet is an ECN-capable packet and whether or not congestion has been experienced. A sender of network traffic may indicate a packet as ECN-capable or non-ECN-capable based on whether the sender is ECN-capable. If an ECN-capable packet experiences congestion at the egress queue of a switch, router, and/or other network component, such switch, router, and/or other network component may mark the packet as experiencing congestion. When the packet reaches the ECN-capable receiver (destination endpoint), the receiver echoes the congestion indicator to the sender (source endpoint) by sending a packet marked to indicate congestion, and after receiving the congestion indicator from the receiver, the source endpoint reduces the transmission rate to relieve the congestion,” as described in “Understanding CoS Explicit Congestion Notification,” Juniper Product and Release Support, Nov. 29, 2023, the contents of which are hereby incorporated by reference herein in their entirety.

As shown in FIG. 4, in some embodiments, two ECN bits in the DiffServ field provide four codes that determine if a packet is marked as an ECN-capable transport (ECT) packet, meaning that both endpoints of the transport protocol are ECN-capable, and if there is congestion experienced (CE). Historically, codes 01 and 10 had the same meaning, namely that the sending and receiving endpoints of the transport protocol are ECN-capable, and there was no difference between these codes. Recent work, however, earmarks ECT (1) as the bit pattern for L4S-capable traffic. System 100 may modify such interpretation of the ECN bits by assigning distinct meanings to ECT (0) and ECT (1) in order to designate at least two different traffic classes. In some embodiments, ECT (1), e.g., bit pattern 01, may be used to indicate L4S-capable traffic, and ECT (0), e.g., bit pattern 10, may be used to indicate that the sender is capable of receiving explicit congestion notification (though the sender may not be compliant with L4S). In some embodiments, L4S-capable traffic marked by an application server is assigned to ECT (1) and L4S-capable traffic marked by an ISP (e.g., based on customer preferences) is assigned to ECT (0). For example, ECT (0) is used as an internal reference for network traffic that is designated as preferential by the ISP rather than the application provider. In some embodiments, ISPs can independently choose which bit combination represents one of the two classes described above, or multiple ISPs can agree on the definition and/or choice of ECT (0) and ECT (1). In some embodiments, system 100 may add one or more extra bits to be added, specifically to indicate whether such a data packet having such bits was marked by an ISP operator or application service provider providing L4S enablement.

In some embodiments, the same bits that are used for designating whether the client-server are ECN-capable may also be used for marking whether congestion is actually experienced in the network (bits 11: CE). Thus, if a packet has the ECN bits marked as CE, then, in order to classify it as either marked by the application service provider or by the ISP (to meter the traffic accurately and apply policy), the ISP may perform a lookup of that flow identifier (ID) from a prior packet belonging to the same network traffic flow to check its traffic class, to determine whether the sender packet was marked with 10 or 01.

As described in more detail below, system 100 may be configured to enable application service providers and/or the ISP to intelligently determine whether a portion of data being transmitted or to be transmitted to a device (e.g., device 112 or 114 of FIG. 1 at particular location 104 of FIG. 1) over a network (e.g., service provider network 102) should be provided using a first queue for preferential (e.g., LAS-capable) network traffic (e.g., via service flow 206, 210, and/or 218 of FIGS. 2A-2B) and a second queue for non-preferential (e.g., non-L4S) network traffic (e.g., via service flow 208, 212, and/or 220 of FIGS. 2A-2B). For example, system 100 may selectively employ the first queue based on a latency requirement for a portion of the data related to the user experience to be provided to the device on the LAN during a network session, and/or based on other characteristics of such portion of data. In some embodiments, network session data provided to the device on the LAN during a network session may comprise a plurality of portions of data, where certain portions may be treated preferentially (e.g., provided to the device using the first queue) during the network session, and other portions of the data may be treated non-preferentially (e.g., provided to the device using the second queue) during the network session, based on the respective characteristics of such portions. In some embodiments, a network session may be understood as a lasting connection comprising exchange of data packets between a client device and a server, e.g., implemented as a layer in a network protocol.

In some embodiments, such preferential treatment may be selectively turned on and off based on determining whether to employ L4S (or not) for the portions of the network session data. In some embodiments, system 100 may use L4S in conjunction with one or more other techniques, e.g., DiffServ, to forward packets via low latency service flow at the expense of packets over the classic service flow. In some embodiments, if a particular portion of a traffic flow is not LAS-capable, system 100 may cause an ISP and/or application service provider to be informed of the request, which may cause the ISP and/or application service provider to configure the network traffic to be L4S-capable (e.g., via an API call).

FIG. 5 shows illustrative spherical media content, in accordance with some embodiments of this disclosure. Spherical media content 500 may be, for example, XR content, 3D content, a live sports game, recorded or stored content, video-on-demand content, a video game, a website, an application, or any other suitable content, or any combination thereof. Spherical media content 500 may comprise any suitable number of tiles, e.g., 502, 504, 506, 508, 510, 512, 514, 516, 518, 520, 522, 524, 526, 528, 530, 532, 534, 536, 538, 540, 542, 544, 546, 548, 550, 552, 554, 556, 558, 560, 562, 564, 566, 568, 570, 572, 574, 576, 578, 580, 582, 584, 586, 588, 590, 592, 594, 596, and 598 in the example of FIG. 5. A representation of a viewport of an XR device providing spherical media content 500, with a grid of tiles overlaid, is shown. In some embodiments, the viewport may not display the entirety of the spherical media content item; rather it may provide for display only the part of the spherical media content item that is generated for display to the user.

In some embodiments, certain portions of network traffic corresponding to a spherical media content item may be treated preferentially (e.g., LAS-enabled) whereas other portions of the network traffic corresponding to the spherical media content item may be treated non-preferentially (e.g., not L4S-enabled). For example, systems and methods are described herein for generating a viewport for display. When recording using a camera with multiple lenses, an omnidirectional, panoramic or spherical media content item is created by stitching together, via software, the content captured by each lens of the camera. The spherical media content item referred to herein encompasses omnidirectional and panoramic media content items. The spherical media content item may be a monoscopic or a stereoscopic 180-degree or 360-degree recording. In addition, the spherical media content may be in an equirectangular, fisheye or dual fisheye format. A stereoscopic media content item may comprise two equirectangular videos that are stitched together to form an image that is 360 degrees in the horizontal direction and 180 degrees in the vertical direction. The spherical media content item may comprise a plurality of frames, each frame comprising a plurality of tiles. A viewport is the portion of the spherical media content item that is generated for display at user equipment. The spherical media content may comprise tiles that are formed projecting an equirectangular frame and grid onto the spherical content item. Typically, a spherical media content item will be streamed to (or played at) a computing device such as a VR headset; however, a spherical media content item may also be streamed to (or played at) a computing device such as a laptop. In the case of a laptop, the video is flattened, and the user may use, for example, a mouse to move the output of the spherical content item. In the example of the VR headset, as a user moves their head, the VR headset will generate and display different portions of the spherical media content item to the user.

In some embodiments, the spherical media content 500 is provided, e.g., by a content server and/or a web server (e.g., cloud server 124 of FIG. 1) and/or edge server(s) of a CDN, to a device (e.g., device 112 of FIG. 1, which may be, for example, an XR HMD) using the HTTP protocol or any other suitable protocol. In some embodiments, a request received by the web server from device 112 may include HTTP priority parameters for a transport stream. As stated in] Internet Engineering Task Force (IETF), Oku et al. “Extensible Prioritization Scheme for HTTP,” RFC 9218 June 2022, “The priority information is a sequence of key-value pairs, providing room for future extensions. Each key-value pair represents a priority parameter” where such priority parameters are contained in the “Priority HTTP header field, which is an end-to-end priority signal that is independent of protocol version. Clients can send this header field to signal their view of how responses should be prioritized.” RFC 9218 “defines the urgency (u) and incremental (i) priority parameters.”

As further stated in RFC 9218, “The urgency (u) parameter value is Integer . . . between 0 and 7 inclusive, in descending order of priority. The default is 3. Endpoints use this parameter to communicate their view of the precedence of HTTP responses. The chosen value of urgency can be based on the expectation that servers might use this information to transmit HTTP responses in the order of their urgency. The smaller the value, the higher the precedence.” RFC 9218 further states that “[t]he following example shows a request for a CSS file with the urgency set to 0:

```
:method = GET
  :scheme = https
  :authority = example.net
  :path = /style.css
  priority = u=0.”
```

RFC 9218 further states that “[a] client that fetches a document that likely consists of multiple HTTP resources (e.g., HTML) SHOULD assign the default urgency level to the main resource. This convention allows servers to refine the urgency using knowledge specific to the website. . . . The lowest urgency level (7) is reserved for background tasks such as delivery of software updates. This urgency level SHOULD NOT be used for fetching responses that have any impact on user interaction.”

In some embodiments, a request received by a web server (e.g., cloud server 124 of FIG. 1) from device 112 may include one or more incremental parameters. RFC 9218 states that “[t]he incremental (i) parameter value is Boolean. . . . It indicates if an HTTP response can be processed incrementally, i.e., provide some meaningful output as chunks of the response arrive. The default value of the incremental parameter is false (0). If a client makes concurrent requests with the incremental parameter set to false, there is no benefit in serving responses with the same urgency concurrently because the client is not going to process those responses incrementally. Serving non-incremental responses with the same urgency one by one, in the order in which those requests were generated, is considered to be the best strategy. If a client makes concurrent requests with the incremental parameter set to true, serving requests with the same urgency concurrently might be beneficial. Doing this distributes the connection bandwidth, meaning that responses take longer to complete. Incremental delivery is most useful where multiple partial responses might provide some value to clients ahead of a complete response being available.” The following example shows a request for a JPEG file with the urgency parameter set to 5 and the incremental parameter set to true.

:method = GET
:scheme = https
:authority = example.net
:path = /image.jpg
priority = u=5, i”

For example, Google Chromium maps urgency numbers to (0, 1, 2, 3, 4), while Safari uses (0, 1, 3, 5, 7), and Firefox skips 0 (1, 2, 3, 4), e.g., lower number values are more important and indicate higher urgency, regardless of which exact number is used. A developer can set the urgency value in JavaScript API, e.g., using a setUrgency( ) method which takes an integer value as its argument, and which represents the urgency level. The urgency level can be any value from 0 to 10, with 0 being the lowest number (and highest urgency) and 10 being the highest number (and lowest urgency). Another way to set the urgency value is to use the priority property. This property takes a string value as its argument, which represents the urgency level. The urgency level can be one of the following values: “low,” “medium,” and “high.” To set the incremental flag in JavaScript for an HTTP request, the setRequestHeader( ) method can be used with the syntax JavaScript xhr.setRequestHeader (‘Incremental’, ‘true’).

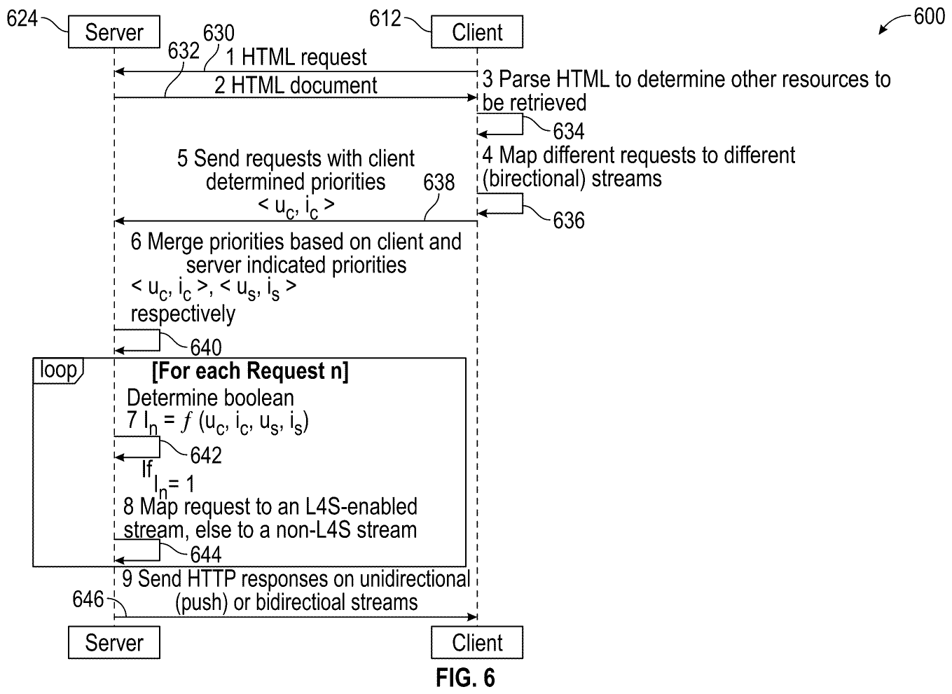

FIG. 6 shows a flowchart of an illustrative process 600 treating portions of a network resource preferentially, in accordance with some embodiments of this disclosure. In various embodiments, the individual steps 630-646 of process 600 may be implemented by one or more components of the devices, methods, and systems of FIGS. 1-5 and 7-15 (e.g., traffic analysis module 121 and/or TIPE module 123 and/or cloud server 124) and may be performed in combination with any of the other processes and aspects described herein. Although the present disclosure may describe certain steps 630-646 of process 600 (and of other processes described herein) as being implemented by certain components of the devices, methods, and systems of FIGS. 1-5 and 7-15, this is for purposes of illustration only, and it should be understood that other components of the devices, methods, and systems of FIGS. 1-5 and 7-15 may implement those steps instead. While this example primarily focuses on using the HTTP protocol, it should be appreciated that the techniques described herein may be used in relation to any suitable protocol for delivering any suitable network resource to clients.

At 630, server 624 (e.g., server 124 of FIG. 1) may receive an HTML request from client device 612 (e.g., device 112 of FIG. 1). At 632, server 624 transmits a network resource (e.g., an HTML document, or spherical media content 500 of FIG. 5) to client device 612. At 634, client device 612 may initially parse the network resource received from server 624 at 632, to understand what additional resources are needed for a complete render. For example, once client device 612 determines the resources needed for the complete render (e.g., based on information received from server 624), client device 612 determines a priority for each resource (or portion thereof) based on its determination of how it must render the complete top-level resource. In some embodiments, at 636, client device 612 may map each of these requests to a stream (e.g., if using bidirectional streams). At 638, client device 612 may send each of these requests to server 624, such as, for example, with the priorities (e.g., urgency parameter and/or incremental parameter) embedded in the HTTP request header of data transmitted to server 624. In some embodiments, if no priorities are set, then the request priority defaults to 3.

In some embodiments, the HTML document indicated at 632 may additionally or alternatively comprise an XML (extensible markup language) document, and/or any other suitable data. The XML document may comprise URLs for requesting data needed for the application. One example is adaptive bit rate (ABR) manifest files, e.g., XML files comprising URLs for retrieving the video and audio streams at different bitrates to be played in an ABR player at client device 612. In some embodiments, HTML document 632 may additionally or alternatively comprise an XML Outline Processor Markup Language (OPML), e.g., an XML file comprising a list of subscriptions to podcasts. This file can be used by podcast players to keep track of the latest episodes from the podcasts that the user is subscribed to. OPML XML files can also comprise URLs to the podcast episodes, which can be used to play the episodes. In some embodiments, HTML document 632 may additionally or alternatively comprise a Really Simple Syndication (RSS) XML, which is an XML file comprising a list of recent articles from a website. This file can be used by newsreaders to keep track of the latest articles from a website. RSS XML files may comprise URLs to the full articles, which can be used to read the articles in full. In some embodiments, HTML document 632 may additionally or alternatively comprise an Atom XML, an XML file similar to an RSS XML file but potentially more flexible and capable of being used to represent a wider variety of data. Atom XML files may comprise URLs to the full articles, which can be used to read the articles in full. In this case, the specific application may be chosen based on the application's determined priority and incremental settings.

At 638, server 624 receives, from client device 612, the requests (e.g., portions of network resource 500) mapped to the priorities/urgencies parameters and/or incremental parameters. For example, the requests may respectively correspond to different portions of spherical media content 500, e.g., different groupings of tiles 502-598, audio of the media content, and/or any other suitable network resources of portions thereof. Server 624 may retrieve or determine its own interpretation of the priorities with which each of the requests should be served, or it may accept the priorities signaled by the client. For example, RFC 9218 states that “[n]o guidance is provided for merging priorities; this is left as an implementation decision. The absence of a priority parameter in an HTTP response indicates the server's determination not to change the client-provided value. This is different from the request header field, in which omission of a priority parameter implies the use of its default value.”

In some embodiments, server 624 may be optimized for the prioritization for the delivery of the data along with enabling or disabling the low latency. In some embodiments, server 624 may be a smart server specifically for playing OTT video. Server 624 may already include optimization for the prioritization for the delivery of the data along with enabling or disabling the low latency. In some embodiments, server 624 may be optimized for prebuffering multiple short-form videos. In these examples, server 624 may understand and/or access information related to the data to be delivered which the client may not have access to (e.g., bandwidth information on the network overall), to help inform urgency parameters to be set to different portions of spherical media content 500.

Urgency values set by client device 612 and/or server 624 for portions of spherical media content 500 may be based on any suitable criteria. For example, as discussed in more detail below, portions of spherical media content 500 that a user is currently focusing on or predicted to be likely to focus on may be given the lowest urgency parameter value (indicating the highest urgency) of each portion of spherical media content 500 (causing video portion 504 content to be processed using a first queue for low latency traffic), and urgency values for requesting various tiles may depend on their distance from the portions of spherical media content 500 that a user is currently focusing on or predicted to be likely to focus on. In some embodiments, client device 612 and/or server 624 may take into account preferences of the user (e.g., user 110) accessing spherical media content 500, preferences of users generally, popularity of certain portions (e.g., a famous celebrity in advertisement 510), preferences of content providers (e.g., an advertiser may pay extra to a website to have their advertisements prioritized, such as the advertiser that provides advertisement 510), and/or any other suitable criteria, in determining urgency values to be assigned to different portions of spherical media content 500. In some embodiments, certain types of resources or portions thereof may generally be assigned lower urgency values (and thus treated more urgently by the network). For example, since a progressive JPEG is typically better than a normal JPEG in terms of a user experience, and potentially less-bandwidth intensive, a progressive JPEG could be loaded with lesser urgency than a normal JPEG (particularly if the JPEG is a “hero image” on the webpage).

At 640, server 624 may merge priorities based on client and server indicated priorities<u_{c}, i_{c}>, <uₛ, iₛ>, respectively. Server 624 may, at 642, determine the client and server priorities for each request (stored, received or merged), for each request, server 624 may calculate a Boolean value lₙ based on these priorities:

$$f ( {u}_{c} , {i}_{c} , {u}_{s} , {i}_{s} ) .$$

where u_{c} is the urgency parameter determined by client device 612 for a particular portion of spherical media content 500, i_{c} is the incremental parameter determined by client device 612 for the particular portion of spherical media content 500, uₛ is the urgency parameter determined by server 624 for a particular portion of spherical media content 500, and iₛ is the incremental parameter determined by server 624 for the particular portion of spherical media content 500. As shown at 644, if the Boolean value is TRUE, then the request response is mapped to an L4S-enabled stream; on the other hand, if the Boolean value is FALSE, then the request response is mapped to a non-L4S stream.

In some embodiments, HTTP server 624 reads only the urgency value of the client request in the header and makes a decision on whether to enable L4S for the response stream (unidirectional, or bidirectional if request and response are on the same stream). In some embodiments, server 624 ignores the value communicated by the client and uses its server-provided urgency value uₛ to determine whether to send the response on an LAS enabled-stream. In some embodiments, server 624 uses some pre-determined logic to blend u_{c} and uₛ into a new value for making a decision as to whether the response shall be LAS-enabled. For example, server 624 may use certain u_{c} values as the urgency parameters for certain portions of spherical media content 500, and may use certain uₛ values as the urgency parameters for certain portions of spherical media content 500, and/or server 624 may determine an average urgency parameter based on u_{c} values and uₛ values, or employ any other suitable techniques in blending the u_{c} values and uₛ values.

$$If {u}_{c / s} \leq V , {l}_{n} = 1$$

$$If {u}_{c / s} > V , {l}_{n} = 0$$

where u_{c/s} denotes the urgency parameter after consideration of both received (from client device 612) and pre-stored at, or otherwise determined at, at server 624 urgency values. The above conditions illustrate specific logic that may be used to determine whether the Boolean value lₙ is TRUE (1) or FALSE (0). If the urgency parameter u_{c/s} is less than or equal to a threshold V, then lₙ is TRUE (since a lower value corresponds to a higher urgency). On the other hand, if urgency parameter u_{c/s} is greater than a threshold V, then lₙ is FALSE. In some embodiments, threshold parameter I may be implementation-dependent, or may be default value, and/or may be set to 0, 1 or 2.

In some embodiments, client device 612 transmits a request for a network resource or portions thereof with information indicating u_{c} and i_{c}, and server 624 may determine, based on u_{c}, i_{c}, uₛ, and/or iₛ, a subset of packets to satisfy the request, which may be delivered with L4S enabled, and another subset of the packets may be delivered with L4S disabled. In this case, the value of the Boolean function may be dependent on other factors in addition to u_{c}, i_{c}, uₛ, and/or iₛ, e.g., chunk size within a segment, such that the value of In may dynamically change between TRUE and FALSE. Based on this dynamically changing mapping of In, each packet that is being delivered to the client device may or may not be L4S-enabled based on the decision by server 624.

In some embodiments, when the urgency parameter for multiple requests (e.g., respective requests for scoreboard portion 508 and advertisement 510) is the same, then server 624 may also consider the incremental parameter in determining whether a request response shall be delivered on an LAS stream (or other preferentially treated stream). Consider, as an example, an HTTP server 624 that is serving requests in decreasing order of urgency (increasing order of the u parameter), e.g., currently it is serving requests that have an urgency value of u=U or higher. If the i parameter of a request response is FALSE, then server 624 may determine that such request should not be loaded incrementally. Thus, when serving requests with u≥U, server 624 may prioritize requests that have i=0 (FALSE) by using an L4S-enabled stream over requests that have i=1 (TRUE), since the latter type of requests can be served while concurrently serving other requests. For requests that have the same u parameter such that u_{c/s}≥V, the server may enable L4S for streams that deliver responses for requests that have an incremental parameter i=0 (FALSE). At 646, server 624 may transmit HTTP responses on unidirectional (push) or bidirectional streams, based on the processing at 644.

The parameters u_{c}, i_{c}, uₛ, and/or iₛ may be used for any suitable application, e.g., short-form video prebuffering, based on anticipated playout. In some embodiments, system 100 (which may implement process 600) may consider bandwidth in determining an amount of a short-form video that is to be simultaneously pre-buffered to enable faster initial playout when scrolling through a list of videos. For example, a list of videos may be transmitted to client device 612 in an XML metadata file that comprises ABR video URLs for each of the short-form video manifest files along with other metadata such as the posting user, reactions, text/comments, and/or any other suitable metadata, for each short-form video. Bitrate ladder values, which may be included in each short-form video's manifest file, may also be included in the XML metadata, and may also be sent to client device 612 in the metadata file. This may prevent client device 612 from having to retrieve the manifest file for all URLs to determine the bitrates that are available each short-form video.

To enable an optimally fast playout, both low latency delivery and bandwidth may considered, leveraging the client device 612's u_{c} and i_{c} for each segment request. When the short-form video application displays a recommended list of short-form videos to a user, system 100 may cause a video to begin playing that is in the viewing position centered in the list or as determined by the short-form video viewing system. Multiple ABR players may be presented in the list, where each ABR player may request segments. In some embodiments, only one ABR player will be playing video, and the ABR player chosen by the short-form video system may make a request of the lowest bitrate segment, to download a segment with an urgency value of u=0 (highest urgency) and I, and calculate a bandwidth. The currently playing video may also leverage the OTT ABR optimization, and in such instance, server 624 may at least partially override the choices received from client 612, since server 624 is optimized for playing OTT ABR video. However, client 612 may not be optimized for prebuffering of an initial segment for multiple ABR players to enable very quick playout when a user scrolls or selects a video to play. In the case of a short-form video being played, server 624 may choose to override u_{c} and i_{c}. Server 624 may enable or disable the L4S markings based on the size of the fragments/chunks, and may still leverage the priority u_{c} value.

Once bandwidth is calculated after the first segment download, and if the user is still watching the video, prebuffering can begin for other ABR players based on a determined value of a video anticipated to be played, available bandwidth value, the bitrate ladders for each of the ABR video players, and/or based on any other suitable data. For any ABR player determined to prebuffer, only one segment may be downloaded for the initial playout, e.g., the buffers may not have to fill. In some embodiments, HTTP requests for the first segment to download can be based on the calculated available bandwidth, and setting the u value may be set appropriately based on its determined priority value on anticipation to be played. During the prebuffering process, requests and/or downloads across the multiple ABR players may be factored in to the overall bandwidth calculation, and, based on bandwidth increasing or decreasing, the number of prebuffering ABR players may increase or decrease along with adjusting the value for each prebuffer request. In some embodiments, the i value is not set for buffering the first segment for each of the ABR players not playing video; the i value may only be set for the player currently playing the ABR video. Handling the priority in such a case allows for control of the bandwidth used when downloading multiple streams, to ensure the currently playing ABR video receives the highest bandwidth allocation in terms of the urgency value.

In some embodiments, server 624 may additionally or alternatively consider file size and/or expected tonnage when determining whether to send a request response on an L4S-enabled stream, in addition to the <u, i> parameters. For example, server 624 may enable L4S on a stream that has an incremental parameter set to FALSE, if the file size is large (e.g., above a threshold, or greater than other portions of the network resource by a certain threshold). By intelligently responding to a network congestion if CE bits are set, server 624 may deliver scalable throughput for a queue-building flow. Thus, by using L4S, server 624 may be able to transmit more data to the client faster.

In some embodiments, server 624 may additionally or alternatively consider interactivity of an element that is rendered at client device 612 while determining whether to send the request response in an LAS-enabled stream. While interactivity of a visual element may often be handled locally at client device 612 once the model has been loaded and rendered, certain types of interactivities may trigger a request back to server 624 or another resource in the cloud that needs computation and delivery of results, or data for rendering as soon as possible. For example, a user is exploring a three-dimensional (3D) space/game that is being rendered perspective-accurate at the client. When the user reaches a checkpoint, such as entry into a new area, or a new level in a game, then a new model/scene may be loaded and executed. In such cases, server 624, being aware of the dependencies on other resources, may send the dynamic, interactive models on bidirectional L4S-enabled streams (or using another preferential network technique). Client device 612 may issue commands back to server 624 over a network on the L4S-enabled stream (or using another preferential network technique), leading to reduced overall latency in computation delivery/rendering.

As another example, server 624 may preload a network/cloud-based-simultaneous localization and mapping (SLAM) spatial map, e.g., used in robotics, drones, self-guided vehicles, XR, and/or other applications. For example, the SLAM system may run locally, but the maps may be stored in the cloud. Each device can update the SLAM map when changes in the maps are identified by the SLAM system running on an XR headset or robotic device. When a robotic device or person wearing an XR headset is moving from an area where the robot or XR device has the spatial map downloaded (e.g., a front yard of a house) to another area (e.g., a front door of the house), it can be anticipated the XR device is about to enter the front door of the house (e.g., which is on the second floor of the house). The house may have three floors, where there is a separate SLAM map for each floor. In this case, u_{c} and i_{c} may be used when requesting the map download. When making the request (e.g., a HTTP/3 request) for the map to be downloaded, the device may request the map of the second floor with a priority value of u=0 and no i flag. The device may also make another request for the download of the first floor with a priority value of u=3 and no i flag. As another example, based on determining (e.g., using historical data for the location) that the upstairs third floor is not visited very often, the request for the third floor map may be made with a priority value u=5 and no i flag.

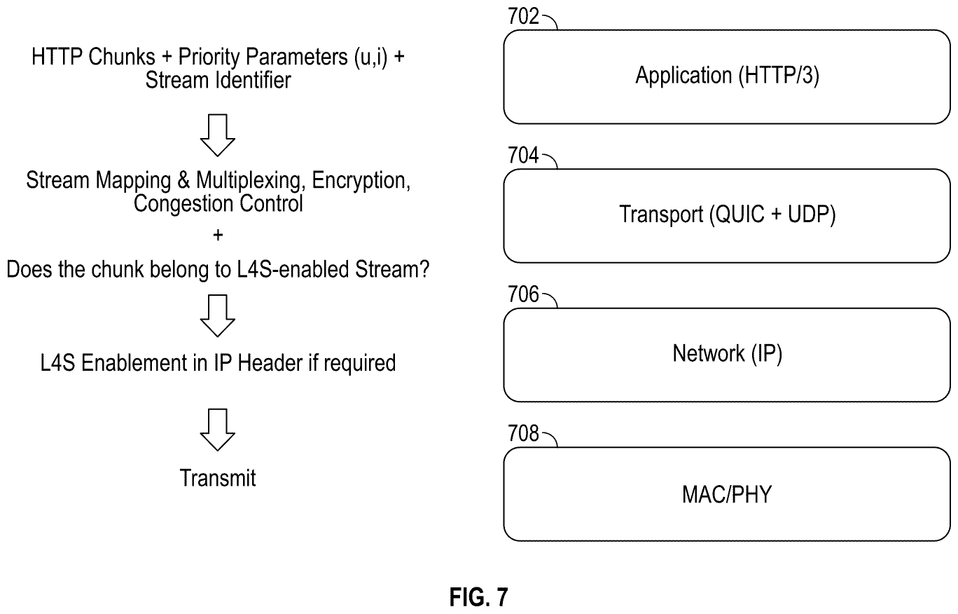

FIG. 7 shows an illustrative block diagram showing different functions performed by various layers in the networking stack of a sender (e.g., a server, such as, for example, server 624 sending HTTPS/3 responses to requests from client device 612), in accordance with some embodiments of this disclosure. At the application layer 702, HTTP chunks are created for a response and passed to transport layer 704 along with the priority parameters (u,i) and a stream identifier, and/or any other suitable parameters. In some embodiments, client device 612 sends an HTTP request on a new stream, using a previously unused stream identifier. Server 624 may send an HTTP response on the same stream as the request. Transport layer 704, which runs QUIC and UDP, performs functions of stream mapping and multiplexing, encryption (e.g., TLS 1.2) and/or congestion control (of each stream). Depending on the stream identifier and its associated priority parameters, this chunk is mapped to an LAS-enabled stream or non-L4S stream. In some embodiments, transport layer 704 then passes the encrypted, multiplexed chunk to the network layer 706, that enables or disables LAS using ECN bits in the IP Header. The IP packet is subsequently translated for sending out on the physical medium 708 (e.g., wired Ethernet, Wi-Fi) by the MAC and PHY functions in the lower layer.

For spherical media content (e.g., 360-degree video), projection maps may be employed that map the spherical FOV to a flat image. For example, an equirectangular projection technique may be utilized which maps the yaw and pitch (longitude and latitude) of a sphere linearly to a rectangular image; a cube mapping technique may be employed, which records the environment as the six faces of a cube; an equi-angular cubemap (EAC) projection, a variant of the cube map technique that distributes the pixels evenly by angle; and/or pyramid projection, a variation of the cube map using a pyramid geometry.

When a DASH client is playing a 360-degree video, the server and/or client device may implement one or more algorithms or techniques to optimize the viewport view based on the bandwidth available and the quality of tiles available. Such algorithms or techniques may be specific to the type of projection map being implemented. In some embodiments, the techniques may include tying HTTP/3, which includes QUIC as the underlying protocol, (or another suitable network protocol), to enable or disable L4S markings (or markings for another suitable preferential network treatment technique).

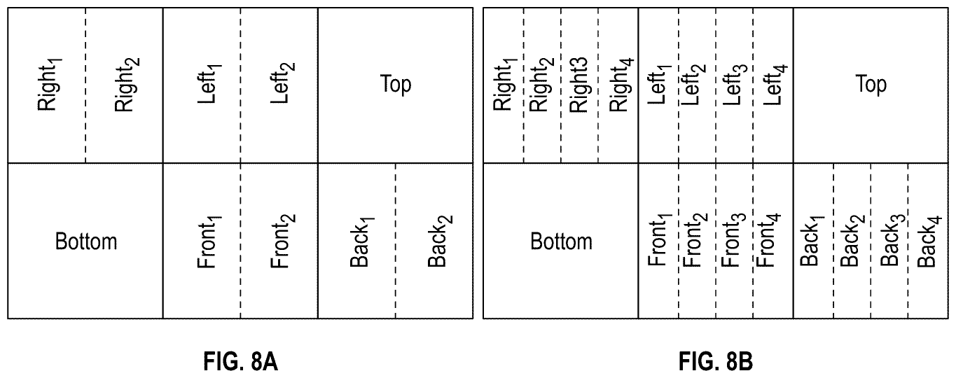

FIGS. 8A-8B show illustrative examples for different tiling schemes for a cube map projection, in accordance with some embodiments of this disclosure. FIGS. 8A-8B may be implemented as a technique for selecting tiles from varying qualities based on where the user is looking for a cube map projection. FIG. 8A shows that only one tile is used for the top, one tile is used for the bottom, and two tiles are used for the right, left, front and back. FIG. 8B uses only one tile for the top, one tile for the bottom and four tiles for the right, left, front and back. The more tiles available for the sections give the client device more options for adjusting bandwidth and quality across the field of view (FOV). If enough tiles are used, there may be different qualities adjusted within the headset FOV based on eye tracking. In this example, only one tile is used for the top and bottom because the top and bottom of the cube map are areas users typically do not look at; however, multiple tiles could additionally or alternatively cover those areas of the cube map.

Any suitable techniques may be used to determine one or more of an FOV of a user, being provided the spherical media content; which tiles to select based on where the user is looking (or likely to look); and/or bandwidth determination. The following algorithm is an algorithm to prioritize tiles in terms of selecting which tiles get higher quality in the viewport versus tiles of lower quality outside the viewport, e.g., when a user changes head position. The availability of the tiles and the qualities are defined in the DASH MPD using the spatial representation description (SRD) feature.

In the MPEG DASH standard, the MPD is an XML document that describes the content available in an adaptive streaming session. It enables client-side adaptation strategies because the content is made available in different characteristics (quality, codec, etc.) by simple HTTP servers. The DASH client decides which content to stream depending, for example, on user preferences and client constraints. DASH allows associating non-timed related information to MPD elements, such as the role of a media asset (e.g., main video or alternate video, subtitle representation, or audio description). The MPD uses descriptor elements to associate such information.

The SRD feature, which was introduced in a later revision of the DASH specification, is used to describe the relationship between blocks in 360-degree space. The SRD feature is used in an adaptive 360° video VR streaming system based on MPEG-DASH. The system uses a dynamic view-aware adaptation technique to address the high bandwidth demands of streaming 360 VR videos to VR headsets. Prior to the definition of SRD, there was no descriptor to associate spatial information with media assets. The SRD feature solves the problem that it was not possible to describe that two videos were representing spatially related parts of a same scene. For example, MP4Box can add an MPD descriptor at adaptation set or representation level. The descriptor source.mp4:desc_as=<SupplementalProperty schemeIdUri=\“urn:mpeg:dash:srd:2014\” value=\“0,0,1,1,1,2,2\”/>indicates that source.mp4 is placed at X=0, Y=1 with width 1 and height 1 on a tiling grid of size 2×2. The following Table 1 defines the SRD feature parameters:

TABLE 1

| EssentialProperty@value or | |
|---|---|
| SupplementalProperty@value | |
| parameter | Description |
| source_id | non-negative integer in decimal |
| | representation providing an identifier for |
| | the source of the content and implicitly |
| | defining a coordinate system |
| object_x | non-negative integer in decimal |
| | representation expressing the horizontal |
| | position of the top-left corner of the |
| | associated media assets in the coordinate |
| | system |
| object_y | non-negative integer in decimal |
| | representation expressing the vertical |
| | position of the top-left corner of the |
| | associated media assets in the coordinate |
| | system |
| object_width | non-negative integer in decimal |
| | representation expressing the width of the |
| | associated media assets in the coordinate |
| | system |
| object_height | non-negative integer in decimal |
| | representation expressing the height of the |
| | associated media assets in the coordinate |
| | system |
| total_width | optional non-negative integer in decimal |
| | representation expressing the width of the |
| | extent of all media assets in the coordinate |
| | system |
| total_height | optional non-negative integer in decimal |
| | representation expressing the height of the |
| | extent of all media assets in the |
| | coordinate system |
| spatial_set_id | optional non-negative integer in decimal |
| | representation providing an identifier for a |
| | group of media assets. |

The following is an example of a DASH Adaptation set in a DASH MPD for various encoding bitrates and resolutions for a tile representation for the SRD definition value=“0,0,0,1,1,3,3”/>. In the full MPD, there may be many more tiles and the following subset is an example representation of one tile across different bitrates and qualities. To make up the full 360 video, there may be many more SRDs and tiles represented in the DASH MPD for the headset to select for viewing.

<AdaptationSet segmentAlignment=“true” maxWidth=“1280” maxHeight=“576”
maxFrameRate=“24” par=“320:144” lang=“und”>
<SupplementalProperty schemeIdUri=“urn:mpeg:dash:srd:2014” value=“0,0,0,1,1,3,3”/>
<Representation id=“1” mimeType=“video/mp4” codecs=“avc1.4d400c” width=“320”
height=“144” frameRate=“24” sar=“1:1” startWithSAP=“1” bandwidth=“102435”>
<SegmentTemplate timescale=“24000” media=“tile1-144p-
100kbps_dash$Number$.m4s” startNumber=“1” duration=“25008” initialization=“tile1-144p-
100kbps_dashinit.mp4”/>
</Representation>
<Representation id=“2” mimeType=“video/mp4” codecs=“avc1.4d400d” width=“320”
height=“144” frameRate=“24” sar=“1:1” startWithSAP=“1” bandwidth=“200458”>
<SegmentTemplate timescale=“24000” media=“tile1-144p-
200kbps_dash$Number$.m4s” startNumber=“1” duration=“25008” initialization=“tile1-144p-
200kbps_dashinit.mp4”/>
</Representation>
<Representation id=“3” mimeType=“video/mp4” codecs=“avc1.4d4015” width=“640”
height=“288” frameRate=“24” sar=“1:1” startWithSAP=“1” bandwidth=“977283”>
<SegmentTemplate timescale=“24000” media=“tile1-288p-
1000kbps_dash$Number$.m4s” startNumber=“1” duration=“25008” initialization=“tile1-288p-
1000kbps_dashinit.mp4”/>
</Representation>
<Representation id=“4” mimeType=“video/mp4” codecs=“avc1.4d4015” width=“640”
height=“288” frameRate=“24” sar=“1:1” startWithSAP=“1” bandwidth=“1216823”>
<SegmentTemplate timescale=“24000” media=“tile1-288p-
1250kbps_dash$Number$.m4s” startNumber=“1” duration=“25008” initialization=“tile1-288p-
1250kbps_dashinit.mp4”/>
</Representation>
<Representation id=“5” mimeType=“video/mp4” codecs=“avc1.4d4015” width=“640”
height=“288” frameRate=“24” sar=“1:1” startWithSAP=“1” bandwidth=“126987”>
<SegmentTemplate timescale=“24000” media=“tile1-288p-
125kbps_dash$Number$.m4s” startNumber=“1” duration=“25008” initialization=“tile1-288p-
125kbps_dashinit.mp4”/>
</Representation>
<Representation id=“6” mimeType=“video/mp4” codecs=“avc1.4d4015” width=“640”
height=“288” frameRate=“24” sar=“1:1” startWithSAP=“1” bandwidth=“1455865”>
<SegmentTemplate timescale=“24000” media=“tile1-288p-
1500kbps_dash$Number$.m4s” startNumber=“1” duration=“25008” initialization=“tile1-288p-
1500kbps_dashinit.mp4”/>
</Representation>
<Representation id=“7” mimeType=“video/mp4” codecs=“avc1.4d4015” width=“640”
height=“288” frameRate=“24” sar=“1:1” startWithSAP=“1” bandwidth=“250248”>
<SegmentTemplate timescale=“24000” media=“tile1-288p-
250kbps_dash$Number$.m4s” startNumber=“1” duration=“25008” initialization=“tile1-288p-
250kbps_dashinit.mp4”/>
</Representation>
<Representation id=“8” mimeType=“video/mp4” codecs=“avc1.4d4015” width=“640”
height=“288” frameRate=“24” sar=“1:1” startWithSAP=“1” bandwidth=“495065”>
<SegmentTemplate timescale=“24000” media=“tile1-288p-
500kbps_dash$Number$.m4s” startNumber=“1” duration=“25008” initialization=“tile1-288p-
500kbps_dashinit.mp4”/>
</Representation>
<Representation id=“9” mimeType=“video/mp4” codecs=“avc1.4d4015” width=“640”
height=“288” frameRate=“24” sar=“1:1” startWithSAP=“1” bandwidth=“53108”>
<SegmentTemplate timescale=“24000” media=“tile1-288p-
50kbps_dash$Number$.m4s” startNumber=“1” duration=“25008” initialization=“tile1-288p-
50kbps_dashinit.mp4”/>
</Representation>
<Representation id=“10” mimeType=“video/mp4” codecs=“avc1.4d4015” width=“640”
height=“288” frameRate=“24” sar=“1:1” startWithSAP=“1” bandwidth=“736998”>
<SegmentTemplate timescale=“24000” media=“tile1-288p-
750kbps_dash$Number$.m4s” startNumber=“1” duration=“25008” initialization=“tile1-288p-
750kbps_dashinit.mp4”/>
</Representation>
<Representation id=“11” mimeType=“video/mp4” codecs=“avc1.4d4015” width=“640”
height=“288” frameRate=“24” sar=“1:1” startWithSAP=“1” bandwidth=“82749”>
<SegmentTemplate timescale=“24000” media=“tile1-288p-
80kbps_dash$Number$.m4s” startNumber=“1” duration=“25008” initialization=“tile1-288p-
80kbps_dashinit.mp4”/>
</Representation>
<Representation id=“12” mimeType=“video/mp4” codecs=“avc1.4d401f” width=“1280”
height=“576” frameRate=“24” sar=“1:1” startWithSAP=“1” bandwidth=“1460068”>
<SegmentTemplate timescale=“24000” media=“tile1-576p-
1500kbps_dash$Number$.m4s” startNumber=“1” duration=“25008” initialization=“tile1-576p-
1500kbps_dashinit.mp4”/>
</Representation>
<Representation id=“13” mimeType=“video/mp4” codecs=“avc1.4d401f” width=“1280”
height=“576” frameRate=“24” sar=“1:1” startWithSAP=“1” bandwidth=“2413190”>
<SegmentTemplate timescale=“24000” media=“tile1-576p-
2500kbps_dash$Number$.m4s” startNumber=“1” duration=“25008” initialization=“tile1-576p-
2500kbps_dashinit.mp4”/>
</Representation>
<Representation id=“14” mimeType=“video/mp4” codecs=“avc1.4d401f” width=“1280”
height=“576” frameRate=“24” sar=“1:1” startWithSAP=“1” bandwidth=“4785828”>
<SegmentTemplate timescale=“24000” media=“tile1-576p-
5000kbps_dash$Number$.m4s” startNumber=“1” duration=“25008” initialization=“tile1-576p-
5000kbps_dashinit.mp4”/>
</Representation>
</AdaptationSet>

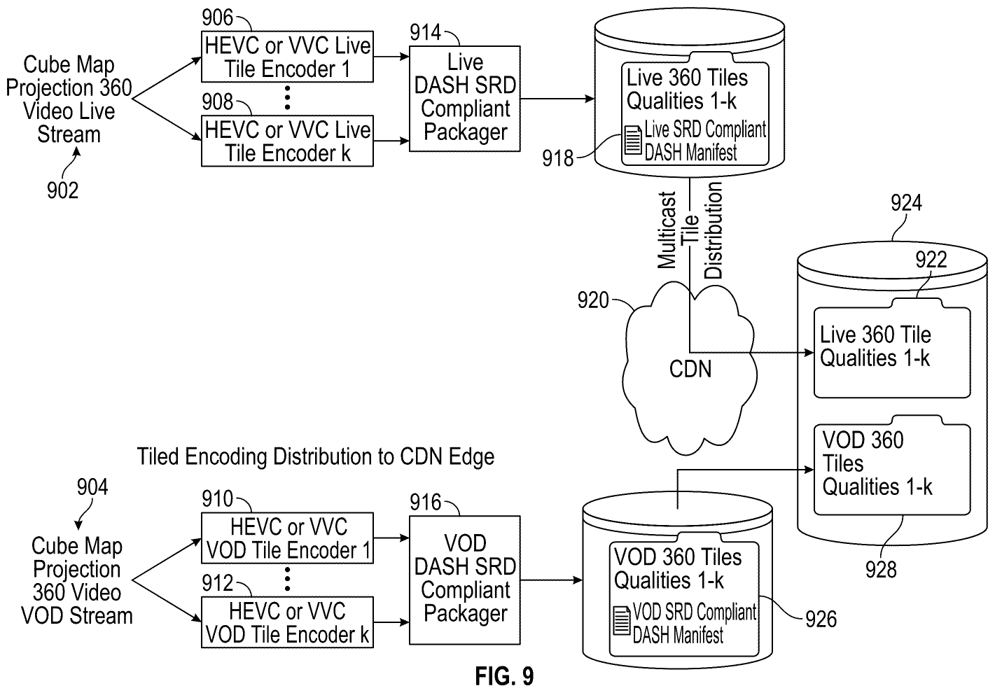

FIG. 9 shows an illustrative example of a tiled encoding system for both live 360-degree content and VOD 360-degree content, in accordance with some embodiments of this disclosure. In this example, the spherical media content (e.g., the live 360-degree content or VOD 360-degree content, such as content 500 of FIG. 5 comprising a plurality of tiles) may have already been mapped into a cube map projection 902 or 904. The incoming stream of live 360-degree content is sent to HEVC or VVC tiled encoders 1-k 906 . . . 908, where k is the maximum number of qualities of tiles covering the full 360-degree cube mapped video. Similarly, the incoming stream of live 360-degree content is sent to HEVC or VVC tiled encoders 1-k 910 . . . 912, where k is the maximum number of qualities of tiles covering the full 360-degree cube mapped video. The live encodings are sent to the live DASH SRD compliant packager 914 where a DASH SRD compliant manifest 918 is generated, and each tile is multiplexed into an MP4 container, written to the CDN origin. CDN 920 multicasts the live 360-degree tiles 922 to the edge nodes 924 of the CDN 920. Similarly, the encodings for the VOD spherical content are transmitted to VOD DASH SRD compliant packager 916 where a DASH SRD compliant manifest 926 is generated, and each tile is multiplexed into an MP4 container, written to the CDN origin. CDN 920 multicasts the VOD 360-degree tiles 928 to the edge nodes 924 of CDN 920.

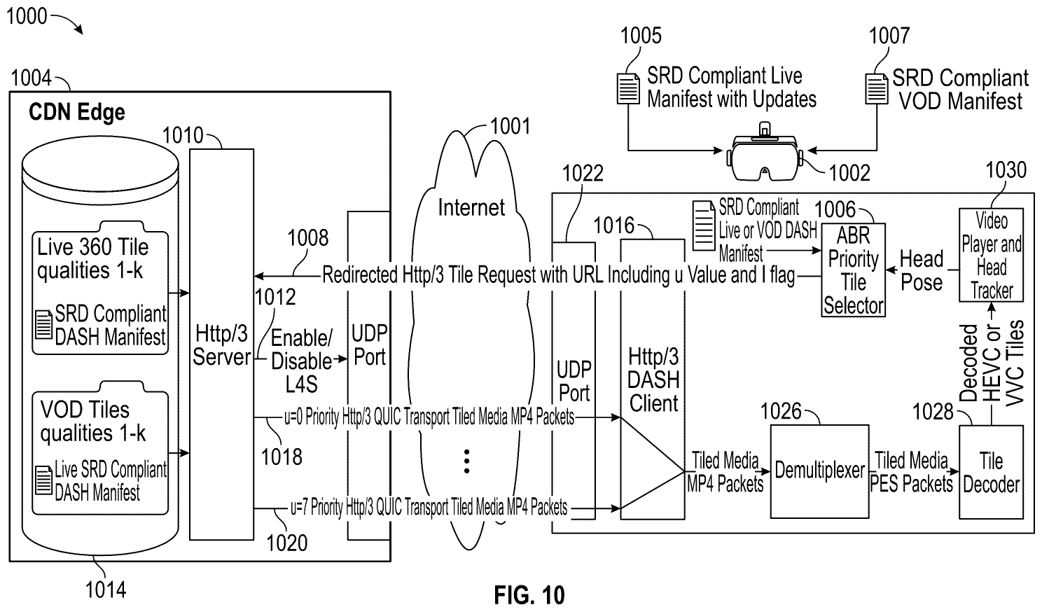

FIG. 10 shows an illustrative example for tiled media delivery using an HTTP/3 QUIC delivery server, in accordance with some embodiments of this disclosure. DASH SRD tiled video delivery leveraging HTTP/3 advantageously provides no head-of-line blocking and utilizes UDP for the packet transport. The ability to define the urgency value in HTTP/3 for the transport of the packets for the highest-priority tiles also improves the bandwidth optimization and for the highest-priority tiles.

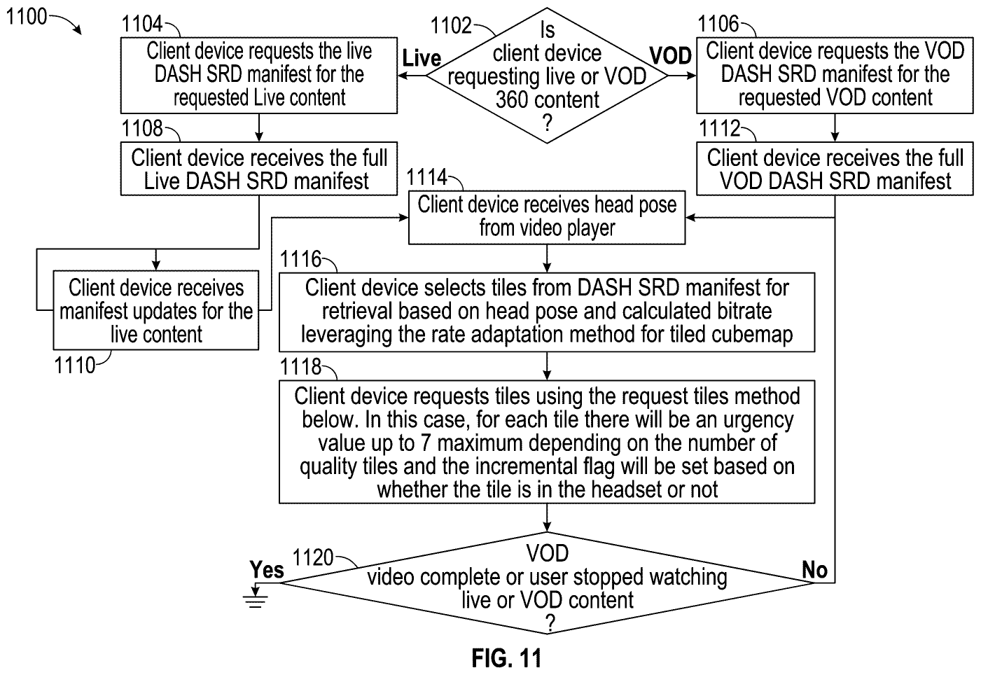

Client device 1002 (e.g., an XR device or other device equipped to provide a spherical media content item to a user) initially requests a live SRD MPD 1005 or a VOD DASH SRD MPD 1007, and client device 1002 begins requesting tiles, e.g., at 1008, via ABR priority tile selector 1006 having a connection over Internet 1001 with HTTP/3 server 1010. Based on values for the urgency parameter(s) and/or incremental parameter(s), HTTP/3 server 1010 of CDN edge server 1004 may, at 1012, enable L4S (or another suitable preferential network treatment protocol) for any tile packets determined to be beyond a priority value or threshold. In some embodiments, if k (indicated at storage or memory 1014 of CDN edge 1004) is equal to the number of qualities (e.g., video qualities for tiles of the spherical media content item), there may be k<7 available. If this is the case, k multiplexed streams may be provided in the HTTP delivery pipeline, each with an urgency mapped to k. As shown at 1018 and 1020, the HTTP/3 server may transmit, to HTTP/3 DASH client 1016 of client device 1002 (via UDP port 1022), QUIC transport tiled media MP4 packets having an urgency of u=0, and QUIC transport tiled media MP4 packets having an urgency parameter of u=7, where a lower parameter value indicates a higher urgency level for the data packet. The tiled media MP4 packets may be provided to demultiplexer 1026, and the multiplexed packets may be provided as tiled media packetized elementary stream (PES) packets to decoder 1028, and decoder 1028 decodes the packets and transmits the decoded HEVC or VVC tiles to video player and head tracker 1030, discussed in more detail in 1116 of FIG. 11 below. Such head pose data may be provided to ABR priority tile selector 1006, to inform what tiles are requested in a preferential manner (e.g., tiles in field of view or gaze of the user).

FIG. 11 shows an illustrative flowchart 1100 for a client device method for the optimized tile selection and delivery for DASH SRD 360-degree content for foveated rendering, in accordance with some embodiments of this disclosure. In various embodiments, the individual steps 1102-1118 of process 1100 may be implemented by one or more components of the devices, methods, and systems of FIGS. 1-10 and 12-15 (e.g., traffic analysis module 121 and/or TIPE module 123 and/or cloud server 124) and may be performed in combination with any of the other processes and aspects described herein. Although the present disclosure may describe certain steps 1102-1118 of process 1100 (and of other processes described herein) as being implemented by certain components of the devices, methods, and systems of FIGS. 1-10 and 12-15, this is for purposes of illustration only, and it should be understood that other components of the devices, methods, and systems of FIGS. 1-10 and 12-15 may implement those steps instead.

The system (e.g., system 100 of FIG. 1 and/or system 500 of FIG. 5) may determine, at 1102, whether a client device (e.g., client device 1002) is requesting live or VOD spherical media content. If live spherical media content is being requested, processing proceeds to 1104, where the client device requests the live DASH SRD manifest for the requested live content; if VOD spherical media content is being requested, processing proceeds to 1106, where the client device requests the VOD DASH SRD manifest for the requested VOD content. At 1108, the client device receives a full live DASH SRD manifest, and at 1110, receives manifest updates for the live content (e.g., from CDN edge server 1004 of FIG. 10). On the other hand, at 1112, in the case of VOD spherical content, the client device receives a full VOD DASH SRD manifest (e.g., from CDN edge server 1004 of FIG. 10). At 1114, the client device receives a gaze, head pose, and/or orientation of the user from the video player (e.g., 1030 of FIG. 1).

For example, to determine the gaze angle or head pose of a user (e.g., user 110 of FIG. 1 wearing or using XR device 112 of FIG. 1), one or more sensors of XR device 112 (or one or more sensors external to XR device 112) may be used to track one or both eyes of a user, to determine a portion a display and/or a portion of the spherical media content (e.g., within an FOV of the user) at which the user's gaze is directed or is focused. For example, an inward-facing or front-facing camera (e.g., disposed adjacent to or under a display of XR device 112 of FIG. 1) may be used to capture any suitable number of images or video of a user's eyes, and such images may be analyzed to track movement of a user's pupil and/or eyelids and/or movement of other portions of a user's eye, to track the eyes of the user, and/or any other suitable technique may be used to track the user's eye (e.g., glint in the user's eyes). In some embodiments a light source (e.g., a light emitting diode (LED) may be configured to illuminate one or both eyes of user 110 with light, and such light may be reflected off a portion(s) (e.g., a retina or cornea) of one or both eyes of user 110 to track different positions of the eye over time, with reference to boundaries of a frame (and/or boundaries of a display) represented by a coordinate system (e.g., X and Y coordinates, or Z coordinates in a three-dimensional system) to determine coordinates on a display of the XR device corresponding to a gaze angle of user 110. The system may use other reference points, such as coordinates of a field of play of a sporting match or sports match, or of any other bounded area, or granular coordinates may be used, e.g., quadrants of a bounded area. In some embodiments, a user may be prompted to calibrate the gaze tracking system, prior to determining at which portion of a display of device 112 user 110 is looking.

In some embodiments, computer-implemented techniques (e.g., machine learning or heuristic-based image recognition) may be used in combination with the sensor data of the user's eyes to determine the user's gaze angle. In some embodiments, the system may determine whether a user has gazed at a portion of the display of device 112 or environment for at least a threshold period of time, as measured by a timer. In some embodiments, the system may determine a rate of change of a user's eyes, and track movement of eyes gazing at different locations. In some embodiments, the orientation of a head of a user may be determined based on user input, e.g., eye tracking, gaze or focus spot of the user, head orientation, touch or voice input, biometric input, and/or any other suitable input.

At 1116, the client device selects tiles from the DASH SRD manifest for retrieval based on the head pose, gaze and/or head orientation determined at 1114, and/or based on a calculated bitrate (e.g., leveraging a rate adaptation method for tiled cubemap, discussed in more detail below, or using any other suitable projection map). For example, tiles may be selected at least in part based on a user preference determined via a sensor of a computing device, for example, by monitoring the head movement and/or gaze of a user to determine how long a user looks at a certain character or a certain scene.

The client device may employ a gaze-adaptive streaming system and/or foveation, i.e., sending a region in the video frame that captures the user's interest with improved quality (such as resolution). These tiles are then requested (at 1118) and are streamed to the VR device at, for example, full resolution and/or a relatively higher bitrate. A full resolution may be, for example, 8K, 4K, 1080p or 720p, or any other suitable resolution, depending on the available bandwidth and/or processing power. Such tiles may be updated at a relatively higher frequency than other tiles of the spherical media content item. On the other hand, tiles not currently in the FOV of the user, or that the user is otherwise determined to be unlikely to be interested in (e.g., based on preference in a user profile), may be transmitted in a relatively lower resolution and/or a relatively lower bitrate.

In some embodiments, when the client device is selecting which tiles from the MPD to request, it may be desirable to maximize the overall quality of the video streamed under limited bandwidth, while the user FOV is streamed at the highest possible quality (Qₘₐₓ) with a gradual degradation of quality for the rest of the tiled cube map. In this referenced algorithm it is assumed the gradual degradation of quality is to follow a normal distribution with steepness (o). A normal distribution may be employed to offer a smooth gradual degradation of quality. The rate adaptation method may be modeled as follows: First, a set of quality levels may be defined, where Q (k) is the quality of tile k. The quality levels are represented as integer values starting from 0 with an increment of one, where 0 is the lowest quality. By assigning generic quality levels, flexibility is provided to use any video quality metric with the method. Second, priorities are assigned to the tiles based on their viewing likelihood for the current user viewport, where P(k) is the priority of tile k. Priorities are integer values starting from 0 with increment of one, where 0 is the highest priority. For each tile the priority can be assigned in multiple ways, which provides flexibility to adapt to different priority models. Priority levels are assigned in a gradual degradation fashion starting with the FOV tiles that have the highest priority, and gradually decreasing the priority as a tiles distance from the FOV tiles increases. The top and the bottom tiles are assigned priorities similar to the next neighboring tiles to the user FOV. Each tile quality may depend on the available bandwidth and the priority assigned to it. Depending on the current viewport, the tiles overlapping with the user's FOV may have the highest priority (P(k)=0), and the value of P(k) may be incremented by 1 as processing moves to the next set of neighboring tiles. The collective quality of all the tiles is maximized, weighted by each tile area A(k), while accounting for their priorities and the bandwidth constraints. The rate adaptation method may be formulated as a maximization problem as shown in Equation (1) below:

$$arg max σ {\sum }_{K} A ( k ) {Q}_{k} ( σ ) subject to {Q}_{k} ( σ ) = {Q}_{max} e - {P ( k )}^{2} / 2 {σ}^{2} , \qquad ( 1 )$$

$${\sum }_{K} r [ {tile}_{k} , {Q}_{k} ( σ ) ] \leq B , 0 \leq {Q}_{k} ( σ ) \leq {Q}_{max} , σ > 0.$$

where r[tileₖ, Qₖ(σ)] is the bitrate of tile k with quality level Qₖ(σ). The 360 video is split into time chunks (C). The bitrate optimization may be performed for each chunk cₜ, while assigning the tiles priorities based on the user viewport. The optimizer assigns the highest quality to the FOV tiles, then tries to increase the steepness of the quality degradation curve to account for higher qualities for the rest of the tiles as much as the bandwidth allows. The optimization problem may be non-linear, and the qualities discrete values, and if bandwidth won't allow the FOV tiles to be streamed with Qₘₐₓ even with all the other tiles being at the lowest quality, Qₘₐₓ may be adjusted manually and the optimization may be performed again.

As discussed above earlier, in HTTP/3, the urgency (u) parameter value is an Integer, between 0 and 7 inclusive, in descending order of priority where 0 is the highest priority and 7 is the lowest priority. The above Equation (1) modification maps the P(k) value or priority value of tile k to an urgency which in turn enables or disables L4S (or another suitable protocol for preferential treatment of network traffic) on each tile request (e.g., based on urgency parameter values and/or incremental parameter values associated with the tiles of the spherical media content item). The full range of urgency values may be utilized. Based on whether the tile is in the FOV or not, the incremental value may be set (or not set) for that tile quality. FOV may also include eye tracking if the number of tiles is large enough that many tiles may be within the XR headset. In HTTP/3, because there is no strict ordering of stream arrival, servers can use stream identifiers to make this determination. Assuming the order of the requests is correct, the system may determine an urgency ordering, e.g., transmitting tiles according to urgency values. For non-incremental requests, the client may be provided the object or resource in full before the object or resource (e.g., one or more tiles of spherical media content) is used or provided to the user. An incremental request allows the client to process data as and when the data arrives. At 1120, if the VOD or live content is still ongoing, processing may return to 1114.

The scheduling of tile delivery may comprise, for each urgency level, serving non-incremental requests in whole serially, then serving incremental requests in round robin fashion in parallel. Such techniques achieve dedicated bandwidth for important tiles, and shared bandwidth for less important tiles that can be processed or rendered progressively. For example, tiles in the FOV may utilize the dedicated bandwidth as they may be considered important. For these tiles, there may be the dedicated bandwidth with L4S enablement, and the tiles outside the FOV may be delivered in round robin fashion without L4S enablement. Another optimization may be made to perform sorting of a data structure for the tiles, to request tiles in ascending order based on the newly added urgency value, resulting in the most urgent tiles being requested first when performing the tile requests. The following is an example of leveraging the disclosed rate adaptation algorithm for tiled cubemap.

| 1 | RateAdaption (C, B, σstep, Qₘₐₓ) | |
|---|---|---|
| 2 | for each cₜ ∈ C do | |
| 3 | Init( ); | σ ← 0.1; σₘₐₓ ← 0; |

| | |
|---|---|
| 4 | do |
| 5 | U ← Σ_{K}A(k) Qₖ(σ); |
| | Qₖ (σ) ← Qₘₐₓ e − P(k)²/2σ² |
| 6 | if Σ_{K}r[tileₖ, Qₖ (σ)] ≤ B then |
| 7 | σₘₐₓ < σ; |
| 8 | σ + σ + σₛₜₑₚ; |
| 9 | else |
| 10 | if σₘₐₓ = 0 and Qₘₐₓ > 0 then |
| 11 | Init( ); |
| 12 | Qₘₐₓ ← Qₘₐₓ − 1; |
| 13 | else |
| 14 | break; Exceeded bandwidth |
| 15 | while U < Σ_{K}A(k) Qₘₐₓ; |
| 16 | foreach tₖ ∈ cₜ do |
| 17 | uₖ = round((Pₖ − Pₖₘᵢₙ) * (Uₘₐₓ − Uₘᵢₙ) / (Pₖₘₐₓ − Pₖₘᵢₙ) + |
| | Uₘᵢₙ); |
| 18 | if tₖ in FOV |
| 19 | iₖ=false; |
| 20 | else |
| 21 | iₖ=true; |
| 22 | Q[cₜ, tₖ, uₖ, iₖ] ← Qₖ(σₘₐₓ); |
| 19 | done; |
| 20 | done; |
| 21 | sort Q[C, T, U, I]; in ascending order based on uₖ |
| 22 | return Q[C, T, U, I]; |

The following is the URL formation for requesting each tile tₖ in time chunk cₜ incorporating the formed urgency value and incremental flag into the URL.

```
Request tiles method
  For each tₖ, ∈ cₜ do
    perform HTTP Tile Request(Q[cₜ, tₖ, uₖ, iₖ])
done;
```

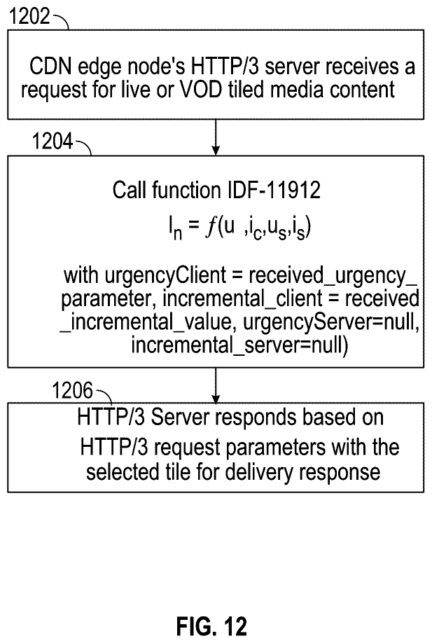

FIG. 12 shows an illustrative flowchart 1200 for a CDN edge node delivery method for optimized tile selection and delivery for DASH SRD 360-degree content for foveated rendering leveraging L4S, in accordance with some embodiments of this disclosure. In various embodiments, the individual steps 1202-1206 of process 1200 may be implemented by one or more components of the devices, methods, and systems of FIGS. 1-11 and 13-15 (e.g., traffic analysis module 121 and/or TIPE module 123 and/or cloud server 124) and may be performed in combination with any of the other processes and aspects described herein. Although the present disclosure may describe certain steps 1202-1206 of process 1200 (and of other processes described herein) as being implemented by certain components of the devices, methods, and systems of FIGS. 1-11 and 13-15, this is for purposes of illustration only, and it should be understood that other components of the devices, methods, and systems of FIGS. 1-11 and 13-15 may implement those steps instead.

At 1202, a CDN edge node's server (e.g., an HTTP/3 server, such as, for example, server 1004 of FIG. 10) receives a request, from a client device (e.g., client device 1002 of FIG. 10) for live or VOD spherical media content. At 1204, the function ƒ(u_{c}, i_{c}, uₛ, is) described above may be leveraged to enable LAS (or another suitable technique for preferentially treating portions of network traffic corresponding to tiles of a spherical media content item), as defined in the value of the client's defined incremental flag in the URL request. In this case, every tile within the viewport view, regardless of urgency, may have its incremental value to true, as discussed in relation to FIG. 11. Implementation of ƒ(u_{c}, i_{c}, uₛ, is):

| | |
|---|---|
| 1 | If (i_{c} == true) |
| 2 | return false; |
| 3 | else |
| 4 | return true; |

At 1206, the server transmits a response to the client device based on HTTP/3 request parameters with the selected tile for a delivery response.

Although one or more of the disclosed techniques relates to the SRD feature in the MPEG-DASH specification using a cube map projection map format, it should be appreciated that the techniques described herein may be employed with any suitable foveated rendering scheme with regions/tiles of varying quality as well as any suitable projection map format. The disclosed techniques may comprise, in delivering one or more portions of a spherical media content item, mapping the visual regions to be transmitted in descending order of quality starting with the region of highest quality (the foveated region) to a descending order of the (client-side) urgency parameter in HTTP. In some embodiments, certain portions of the 360-degree video may be delivered using L4S, e.g., using a mapping function from an HTTP urgency value to a Boolean result for enabling L4S at the transport layer.

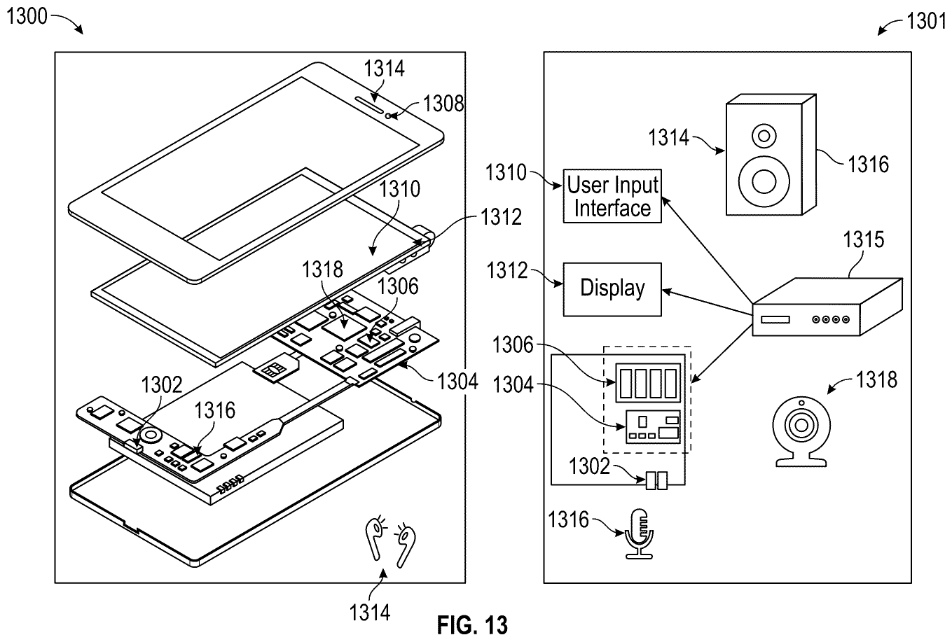

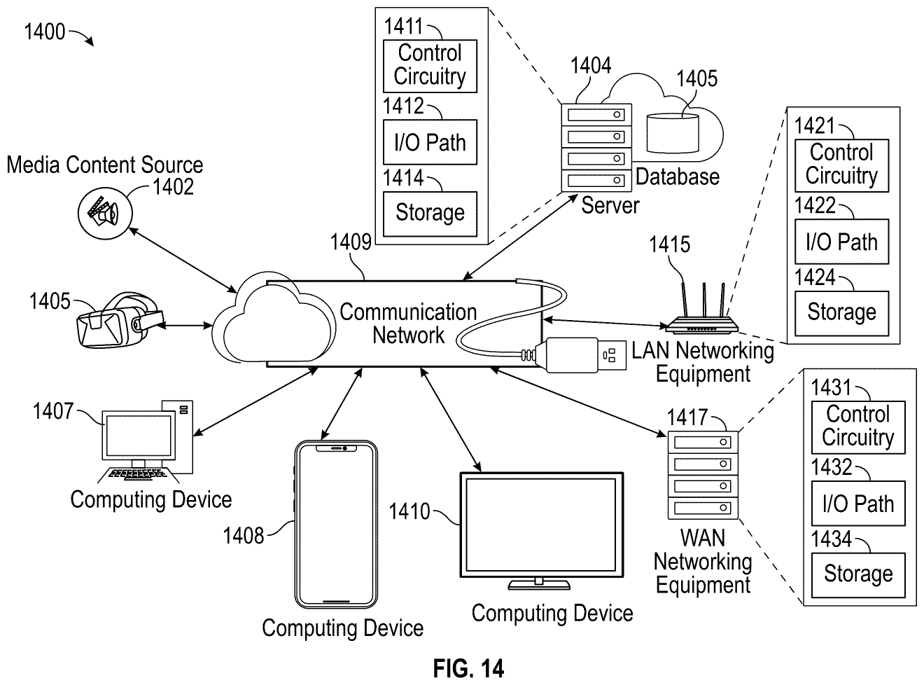

FIGS. 13-14 show illustrative devices, systems, servers, and related hardware for using priority parameters in receiving and/or transmitting tiles of spherical media content, in accordance with some embodiments of this disclosure. FIG. 13 shows generalized embodiments of illustrative computing devices 1300 and 1301, which may correspond to, e.g., a smart phone; a tablet; a laptop computer; a personal computer; a desktop computer; a smart television; a smart watch or wearable device; smart glasses; a stereoscopic display; a wearable camera; virtual reality (VR) glasses; VR goggles; a stereoscopic display; augmented reality (AR) glasses; an AR HMD; a VR HMD; or any other suitable computing device; or any combination thereof. In another example, computing device 1301 may be a user television equipment system or device. In some embodiments, computing devices 1300 and 1301 may correspond to, e.g., device 112 or device 114 of FIG. 1.

User television equipment device 1301 may include set-top box 1315. Set-top box 1315 may be communicatively connected to microphone 1316, Audio output equipment (e.g., speaker or headphones 1314), and display 1312. In some embodiments, microphone 1316 may receive audio corresponding to a voice of a user providing input. In some embodiments, display 1012 may be a television display or a computer display. In some embodiments, set-top box 1315 may be communicatively connected to user input interface 1310. In some embodiments, user input interface 1310 may be a remote control device. Set-top box 1315 may include one or more circuit boards. In some embodiments, the circuit boards may include control circuitry, processing circuitry, and storage (e.g., RAM, ROM, hard disk, removable disk, etc.). In some embodiments, the circuit boards may include an input/output path. More specific implementations of computing devices are discussed below in connection with FIG. 11. In some embodiments, computing device 1300 may comprise any suitable number of sensors (e.g., gyroscope or accelerometer, etc.), and/or a GPS module (e.g., in communication with one or more servers and/or cell towers and/or satellites) to ascertain a location of computing device 1300. In some embodiments, computing device 1300 comprises a rechargeable battery that is configured to provide power to the components of the device.

Each one of computing device 1300 and computing device 1301 may receive content and data via input/output (I/O) path 1302. I/O path 1302 may provide content (e.g., broadcast programming, on-demand programming, Internet content, content available over a local area network (LAN) or wide area network (WAN), and/or other content) and data to control circuitry 1304, which may comprise processing circuitry 1306 and storage 1308. Control circuitry 1304 may be used to send and receive commands, requests, and other suitable data using I/O path 1302, which may comprise I/O circuitry. I/O path 1302 may connect control circuitry 1304 (and specifically processing circuitry 1306) to one or more communications paths (described below). I/O functions may be provided by one or more of these communications paths, but are shown as a single path in FIG. 13 to avoid overcomplicating the drawing. While set-top box 1015 is shown in FIG. 13 for illustration, any suitable computing device having processing circuitry, control circuitry, and storage may be used in accordance with the present disclosure. For example, set-top box 1315 may be replaced by, or complemented by, a personal computer (e.g., a notebook, a laptop, a desktop), a smartphone (e.g., computing device 1000), an XR device; a tablet; a network-based server hosting a user-accessible client device; a non-user-owned device; any other suitable device; or any combination thereof.

Control circuitry 1304 may be based on any suitable control circuitry such as processing circuitry 1306. As referred to herein, control circuitry should be understood to mean circuitry based on one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores) or supercomputer. In some embodiments, control circuitry may be distributed across multiple separate processors or processing units, for example, multiple of the same type of processing units (e.g., two Intel Core i7 processors) or multiple different processors (e.g., an Intel Core i5 processor and an Intel Core i7 processor). In some embodiments, control circuitry 1304 executes instructions for the system or application stored in memory (e.g., storage 1308). Specifically, control circuitry 1304 may be instructed by the system or application to perform the functions discussed above and below. In some implementations, processing or actions performed by control circuitry 1304 may be based on instructions received from the system or application.

In client/server-based embodiments, control circuitry 1304 may include communications circuitry suitable for communicating with a server or other networks or servers. The system or application may be a stand-alone application implemented on a device or a server. The system or application may be implemented as software or a set of executable instructions. The instructions for performing any of the embodiments discussed herein of the system or application may be encoded on non-transitory computer-readable media (e.g., a hard drive, random-access memory on a DRAM integrated circuit, read-only memory on a BLU-RAY disk, etc.). For example, the instructions may be stored in storage 1308, and executed by control circuitry 1304 of a computing device 1300.

In some embodiments, the system or application may be a client/server application where only the client application resides on device 1300 (e.g., device 112 or 114 of FIG. 1), and a server application resides on an external server (e.g., server 1404 of FIG. 14). For example, the system or application may be implemented partially as a client application on control circuitry 1304 of device 1300 and partially on server 1404 as a server application running on control circuitry 1411. Server 1404 may be a part of a local area network with one or more of computing devices 1300, 1301 or may be part of a cloud computing environment accessed via the Internet. In a cloud computing environment, various types of computing services for performing searches on the Internet or informational databases, providing video communication capabilities, providing storage (e.g., for a database) or parsing data are provided by a collection of network-accessible computing and storage resources (e.g., server 1404 and/or an edge computing device), referred to as “the cloud.” Device 1300 may be a cloud client that relies on the cloud computing capabilities from server 1404 to determine whether processing (e.g., at least a portion of virtual background processing and/or at least a portion of other processing tasks) should be offloaded from the mobile device, and facilitate such offloading. When executed by control circuitry of server 1404, the system or application may instruct control circuitry 1411 to perform processing tasks for the client device and facilitate applying preferential treatment on the WAN to certain network traffic corresponding to data requested by a device on a LAN. The client application may instruct control circuitry 1304 to determine where processing should be performed.

Control circuitry 1304 may include communications circuitry suitable for communicating with a server, edge computing systems and devices, a table or database server, or other networks or servers The instructions for carrying out the above mentioned functionality may be stored on a server (which is described in more detail in connection with FIG. 14. Communications circuitry may include a cable modem, an integrated services digital network (ISDN) modem, a digital subscriber line (DSL) modem, a telephone modem, Ethernet card, or a wireless modem for communications with other equipment, or any other suitable communications circuitry. Such communications may involve the Internet or any other suitable communication networks or paths (which is described in more detail in connection with FIG. 14). In addition, communications circuitry may include circuitry that enables peer-to-peer communication of computing devices, or communication of computing devices in locations remote from each other (described in more detail below).

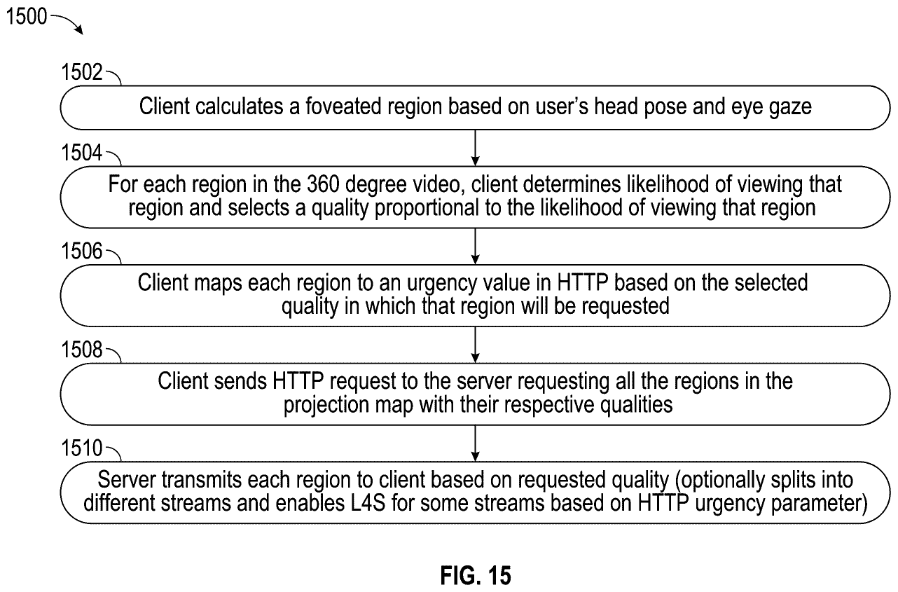

Memory may be an electronic storage device provided as storage 1308 that is part of control circuitry 1304. As referred to herein, the phrase “electronic storage device” or “storage device” should be understood to mean any device for storing electronic data, computer software, or firmware, such as random-access memory, read-only memory, hard drives, optical drives, digital video disc (DVD) recorders, compact disc (CD) recorders, BLU-RAY disc (BD) recorders, BLU-RAY 3D disc recorders, digital video recorders (DVR, sometimes called a personal video recorder, or PVR), solid state devices, quantum storage devices, gaming consoles, gaming media, or any other suitable fixed or removable storage devices, and/or any combination of the same. Storage 1308 may be used to store various types of content described herein as well as the system or application data described above. Nonvolatile memory may also be used (e.g., to launch a boot-up routine and other instructions). Cloud-based storage, described in more detail in relation to FIG. 15, may be used to supplement storage 1308 or instead of storage 1308.

Control circuitry 1304 may include video generating circuitry and tuning circuitry, such as one or more analog tuners, one or more MPEG-2 decoders or MPEG-2 decoders or decoders or HEVC decoders or any other suitable digital decoding circuitry, high-definition tuners, or any other suitable tuning or video circuits or combinations of such circuits. Encoding circuitry (e.g., for converting over-the-air, analog, or digital signals to MPEG or HEVC or any other suitable signals for storage) may also be provided. Control circuitry 1304 may also include scaler circuitry for upconverting and down converting content into the preferred output format of computing device 1300. Control circuitry 1304 may also include digital-to-analog converter circuitry and analog-to-digital converter circuitry for converting between digital and analog signals. The tuning and encoding circuitry may be used by computing device 1300, 1301 to receive and to display, to play, or to record content. The tuning and encoding circuitry may also be used to receive video communication session data. The circuitry described herein, including for example, the tuning, video generating, encoding, decoding, encrypting, decrypting, scaler, and analog/digital circuitry, may be implemented using software running on one or more general purpose or specialized processors. Multiple tuners may be provided to handle simultaneous tuning functions (e.g., watch and record functions, picture-in-picture (PIP) functions, multiple-tuner recording, etc.). If storage 1308 is provided as a separate device from computing device 1300, the tuning and encoding circuitry (including multiple tuners) may be associated with storage 1308.

Control circuitry 1304 may receive instruction from a user by way of user input interface 1310. User input interface 1310 may be any suitable user interface, such as a remote control, mouse, trackball, keypad, keyboard, touchscreen, touchpad, stylus input, joystick, voice recognition interface, or other user input interfaces. Display 1312 may be provided as a stand-alone device or integrated with other elements of each one of computing device 1300 and computing device 1301. For example, display 1312 may be a touchscreen or touch-sensitive display. In such circumstances, user input interface 1310 may be integrated with or combined with display 1312. In some embodiments, user input interface 1310 includes a remote-control device having one or more microphones, buttons, keypads, any other components configured to receive user input or combinations thereof. For example, user input interface 1310 may include a handheld remote-control device having an alphanumeric keypad and option buttons. In a further example, user input interface 1310 may include a handheld remote-control device having a microphone and control circuitry configured to receive and identify voice commands and transmit information to set-top box 1315.

Audio output equipment 1314 may be integrated with or combined with display 1312. Display 1312 may be one or more of a monitor, a television, a liquid crystal display (LCD) for a mobile device, amorphous silicon display, low-temperature polysilicon display, electronic ink display, electrophoretic display, active matrix display, electro-wetting display, electro-fluidic display, cathode ray tube display, light-emitting diode display, electroluminescent display, plasma display panel, high-performance addressing display, thin-film transistor display, organic light-emitting diode display, surface-conduction electron-emitter display (SED), laser television, carbon nanotubes, quantum dot display, interferometric modulator display, or any other suitable equipment for displaying visual images. A video card or graphics card may generate the output to the display 1312. Audio output equipment 1314 may be provided as integrated with other elements of each one of computing device 1300 and computing device 1301 or may be stand-alone units. An audio component of videos and other content displayed on display 1312 may be played through speakers (or headphones) of audio output equipment 1314. In some embodiments, audio may be distributed to a receiver (not shown), which processes and outputs the audio via speakers of audio output equipment 1314. In some embodiments, for example, control circuitry 1304 is configured to provide audio cues to a user, or other audio feedback to a user, using speakers of audio output equipment 1314. There may be a separate microphone 1316 or audio output equipment 1314 may include a microphone configured to receive audio input such as voice commands or speech. For example, a user may speak letters, words, terms and/or numbers that are received by the microphone and converted to text by control circuitry 1304. In a further example, a user may voice commands that are received by a microphone and recognized by control circuitry 1304. Camera 1318 may be any suitable video camera integrated with the equipment or externally connected. Camera 1318 may be a digital camera comprising a charge-coupled device (CCD) and/or a complementary metal-oxide semiconductor (CMOS) image sensor. Camera 1318 may be an analog camera that converts to digital images via a video card.

The system or application may be implemented using any suitable architecture. For example, it may be a stand-alone application wholly-implemented on each one of computing device 1300 and computing device 1301. In such an approach, instructions of the application may be stored locally (e.g., in storage 1308), and data for use by the application is downloaded on a periodic basis (e.g., from an out-of-band feed, from an Internet resource, or using another suitable approach). Control circuitry 1304 may retrieve instructions of the application from storage 1308 and process the instructions to provide the functionality, and generate any of the displays, discussed herein. Based on the processed instructions, control circuitry 1304 may determine what action to perform when input is received from user input interface 1310. For example, movement of a cursor on a display up/down may be indicated by the processed instructions when user input interface 1310 indicates that an up/down button was selected. An application and/or any instructions for performing any of the embodiments discussed herein may be encoded on computer-readable media. Computer-readable media includes any media capable of storing data. The computer-readable media may be non-transitory including, but not limited to, volatile and non-volatile computer memory or storage devices such as a hard disk, floppy disk, USB drive, DVD, CD, media card, register memory, processor cache, Random Access Memory (RAM), etc.

Control circuitry 1304 may allow a user to provide user profile information or may automatically compile user profile information. For example, control circuitry 1304 may access and monitor network data, video data, audio data, processing data, historical interactions by the user, and/or any other suitable data. Control circuitry 1304 may obtain all or part of other user profiles that are related to a particular user (e.g., via social media networks), and/or obtain information about the user from other sources that control circuitry 1304 may access. As a result, a user can be provided with a unified experience across the user's different devices.

In some embodiments, the system or application is a client/server-based application. Data for use by a thick or thin client implemented on each one of computing device 1300 and computing device 1301 may be retrieved on-demand by issuing requests to a server remote to each one of computing device 1300 and computing device 1301. For example, the remote server may store the instructions for the application in a storage device. The remote server may process the stored instructions using circuitry (e.g., control circuitry 1304) and generate the displays discussed above and below. The client device may receive the displays generated by the remote server and may display the content of the displays locally on computing device 1300. This way, the processing of the instructions is performed remotely by the server while the resulting displays (e.g., that may include text, a keyboard, or other visuals) are provided locally on computing device 1300. Computing device 1300 may receive inputs from the user via input interface 310 and transmit those inputs to the remote server for processing and generating the corresponding displays. For example, computing device 1300 may transmit a communication to the remote server indicating that an up/down button was selected via input interface 310. The remote server may process instructions in accordance with that input and generate a display of the application corresponding to the input (e.g., a display that moves a cursor up/down). The generated display is then transmitted to computing device 1300 for presentation to the user.

In some embodiments, the system or application may be downloaded and interpreted or otherwise run by an interpreter or virtual machine (run by control circuitry 1304). In some embodiments, system or application may be encoded in the ETV Binary Interchange Format (EBIF), received by control circuitry 1304 as part of a suitable feed, and interpreted by a user agent running on control circuitry 1304. For example, the system or application may be an EBIF application. In some embodiments, the system or application may be defined by a series of JAVA-based files that are received and run by a local virtual machine or other suitable middleware executed by control circuitry 1304. In some of such embodiments (e.g., those employing MPEG-2, MPEG-4, HEVC or any other suitable digital media encoding schemes), the system or application may be, for example, encoded and transmitted in an MPEG-2 object carousel with the MPEG audio and video packets of a program.

FIG. 14 is a diagram of an illustrative system 1400 for using priority parameters in receiving and/or transmitting tiles of spherical media content, in accordance with some embodiments of this disclosure. Computing devices 1405, 1407, 1408, 1410 (which may correspond to, e.g., computing device 2000 or 2001) may be coupled to communication network 1409. Communication network 1409 may be one or more networks including the Internet, a mobile phone network, mobile voice or data network (e.g., a 5G, 4G, or LTE network), cable network, public switched telephone network, satellite network, or other types of communication network or combinations of communication networks. Paths (e.g., depicted as arrows connecting the respective devices to the communication network 1409) may separately or together include one or more communications paths, such as a satellite path, a fiber-optic path, a cable path, a path that supports Internet communications (e.g., IPTV), free-space connections (e.g., for broadcast or other wireless signals), or any other suitable wired or wireless communications path or combination of such paths. Communications with the client devices may be provided by one or more of these communications paths but are shown as a single path in FIG. 15 to avoid overcomplicating the drawing. In some embodiments, communication network 1409 may correspond to service provider network 102.

LAN networking equipment 1415 may correspond to, for example, networking equipment 106 and/or 108 (e.g., router, gateway, switch, and/or modem and/or other suitable equipment) of FIG. 1. LAN networking equipment 1415 may comprise control circuitry 1421, I/O path 1422, and storage 1424. WAN networking equipment 1417 may correspond to, for example, networking equipment 122 (e.g., a backbone or carrier router or CMTS other suitable networking equipment) of FIG. 1. WAN networking equipment 1417 may comprise control circuitry 1431, I/O path 1432, and storage 1434.

Although communications paths are not drawn between computing devices, these devices may communicate directly with each other via communications paths as well as other short-range, point-to-point communications paths, such as USB cables, IEEE 1394 cables, wireless paths (e.g., Bluetooth, infrared, IEEE 702-11x, etc.), or other short-range communication via wired or wireless paths. The computing devices may also communicate with each other directly through an indirect path via communication network 1409.

System 1400 may comprise media content source 1402, one or more servers 1404, and/or one or more edge computing devices. In some embodiments, system or application may be executed at one or more of control circuitry 1411 of server 1404 (and/or control circuitry of computing devices 1405, 1407, 1408, 1410 and/or control circuitry of one or more edge computing devices). In some embodiments, media content source 1402 and/or server 1404 may be configured to facilitate network traffic between computing devices 1405, 1407, 1408, 1410 and/or any other suitable computing devices, and/or host or otherwise be in communication (e.g., over network 1409) with one or more application services. In some embodiments, server 1404 may perform actions to facilitate processing network traffic based on received user input as described herein.

In some embodiments, server 1404 may include control circuitry 1411 and storage 1414 (e.g., RAM, ROM, Hard Disk, Removable Disk, etc.). Storage 1414 may store one or more databases. Server 1404 may also include an input/output path 1412. I/O path 1412 may provide network traffic information, user preferences, device information, or other data, over a LAN or WAN, and/or other content and data to control circuitry 1411, which may include processing circuitry, and storage 1414. Control circuitry 1411 may be used to send and receive commands, requests, and other suitable data using I/O path 1412, which may comprise I/O circuitry. I/O path 1412 may connect control circuitry 1411 (and specifically control circuitry) to one or more communications paths.

Control circuitry 1411 may be based on any suitable control circuitry such as one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores) or supercomputer. In some embodiments, control circuitry 1411 may be distributed across multiple separate processors or processing units, for example, multiple of the same type of processing units (e.g., two Intel Core i7 processors) or multiple different processors (e.g., an Intel Core i5 processor and an Intel Core i7 processor). In some embodiments, control circuitry 1411 executes instructions for an emulation system application stored in memory (e.g., the storage 1414). Memory may be an electronic storage device provided as storage 1414 that is part of control circuitry 1411.

FIG. 15 is a flowchart of a detailed illustrative process for using priority parameters in receiving and/or transmitting tiles of spherical media content, in accordance with some embodiments of this disclosure. In various embodiments, the individual steps of process 1500 may be implemented by one or more components of the devices, methods, and systems of FIGS. 1-14 and may be performed in combination with any of the other processes and aspects described herein. Although the present disclosure may describe certain steps of process 1500 (and of other processes described herein) as being implemented by certain components of the devices, methods, and systems of FIGS. 1-14, this is for purposes of illustration only, and it should be understood that other components of the devices, methods, and systems of FIGS. 1-14 may implement those steps instead.

At 1502, control circuitry (e.g., control circuitry 1304 of device 1300, which may correspond to XR device 112 of FIG. 1) of a client device may calculate a foveated region of a spherical media content item (e.g., spherical media content item 500 of FIG. 5). The spherical media content item may correspond to any suitable XR content, 360-degree video, immersive content, 3D content, or any combination thereof. In some embodiments, the control circuitry may calculate the foveated region based at least in part on a user's (e.g., user 110 of FIG. 1) head pose and eye pose. In some embodiments, one or more servers (e.g., control circuitry 1411 of server 1404) may be used, at least in part, to calculate the foveated region, e.g., based on sensor data and/or user preference data received from the client device. For example, the spherical content item may be requested by a user (e.g., user 110) wearing or using a device (e.g., device 114 of FIG. 1), and 1502 may be performed prior to receiving, or based on receiving, such request.

The request may be received during a network session from one or more servers and/or databases to one or more devices. In some embodiments, the network may correspond to an LAN and/or WAN and/or any other suitable network (e.g., communications network 1409 of FIG. 14). In some embodiments, the network session may be established automatically or based on a request received from the device. Such request may be received from, for example, a device (e.g., device 112 or 114 of FIG. 1. In some embodiments, the device may be connected to an LAN (e.g., a Wi-Fi network) at a particular location (e.g., location 104 of FIG. 1, which may be a home or residence of user 110 or any other suitable type of location). For example, router, modem, and/or gateway 106 and/or 108 may be used to provide such LAN, to enable the devices to connect to the Internet and access any suitable application or service.

Control circuitry (e.g., 1021 of LAN networking equipment 1015 and/or 1031 of WAN networking equipment 1017) provides a first queue for preferential network traffic and a second queue for non-preferential traffic. For example, the first queue may comprise a buffer for a low latency service flow (e.g., 206, 210, 218 of FIGS. 2A-2B), such as, for example, for L4S-capable traffic, and the second queue may comprise a buffer for a classic service flow (e.g., service flow 206, 210, and/or 218 of FIGS. 2A-2B), such as, for example, for non-L4S-capable traffic.

At 1504, control circuitry (e.g., of the client device and/or server) may determine, for each region in the 360-degree video, a likelihood of viewing that region, and select a quality proportional to the likelihood of viewing that region. For example, each region may correspond to a one or more tiles (e.g., one of tiles 502-598 of spherical media content item 500 of FIG. 5), or each region may correspond to a portion of one or more tiles, or each region may correspond to multiple tiles or portions thereof. As an example, if the control circuitry determines that a user's gaze is directed at portion(s) of spherical media content item 500 of FIG. 5 corresponding to tile 546 and 560 (e.g., the current location of the football), or that a user is likely to be interested in a region (e.g., based on current or previous user inputs, metadata of the spherical media content, user preferences, historical viewing patterns of the user associated with a user profile, a region where a majority of users concentrate on for such spherical media asset or for region where a majority of users concentrate on for a particular type (e.g., football) of spherical media asset, and/or based on any other suitable data).

In some embodiments, the likelihood of viewing for each region may be determined based on its distance from the tiles in a region of interest (ROI) (e.g., tile 546 and 560, the location of the football) identified as a portion of the spherical media content at which the user's gaze or head pose is directed (or is likely to be directed). For example, the closer to the ROI a particular portion of the content is, the higher likelihood of the user being interested in such portion. Additionally or alternatively, any regions within a threshold distance from the ROI may be assigned a higher likelihood of the user viewing that region (e.g., regions 548 and 562 may be assigned the same likelihood, or a slightly lower likelihood, as the ROI tiles 546 and 560, whereas tiles 552 and 554, or tiles 570 or 584, may be assigned relatively lower likelihood. The control circuitry may dynamically update the likelihood over time, e.g., by tracking the flight of the football during a pass, or by tracking a particular main character of a movie, the footballs new location (e.g., in a vicinity of wide receiver, which may be indicated in metadata or otherwise predicted by the control circuitry) or the main character's new location (e.g., indicated in metadata or otherwise predicted by the control circuitry) may be the new ROI assigned the highest likelihood. In some embodiments, in assigning likelihoods of viewing to portions of content, one or more of the techniques described in U.S. Pat. No. 11,716,454 issued in the name of Rovi Guides, Inc., the contents of which are hereby incorporated by reference herein in its entirety.

The control circuitry (e.g., of the client device and/or server) may, for example, select for the ROI assigned the highest likelihood of being viewed, a highest available video quality (e.g., a bitrate and/or resolution, as indicated in a manifest received by the client device). On the other hand, portions of the content likely to be outside the viewport or otherwise not likely to be viewed by the user may be mapped to the lowest available video quality or otherwise a relatively lower video quality than the ROI. Portions of the content located closer to the ROI (e.g., within a threshold distance, which may depend in part on a type of the content) may be assigned a relatively higher video quality than the portions of the content likely to be outside the viewport or otherwise not likely to be viewed by the user.

At 1506, control circuitry (e.g., of the client device and/or server) may, for example, map each region to an urgency value in HTTP based on the assigned or selected quality in which that region will be requested, as determined at 1504. For example, for the ROI,for which a highest available video quality was selected, the control circuitry may assign a lowest urgency value for the urgency parameter (indicating that such portion of content should be processed most urgently as compared to transmittal of the other portions of the spherical media content). On the other hand, portions of the content likely to be outside the viewport or otherwise not likely to be viewed by the user, and thus, mapped to the lowest available video quality or otherwise a relatively lower video quality than the ROI, may be assigned higher urgency values for the urgency parameter (indicating that such portion of content should be processed less urgently). Portions of the content located closer to the ROI (e.g., within a threshold distance, which may depend in part on a type of the content), for which relatively higher video quality has been selected as compared to the portions of the content likely to be outside the viewport or otherwise not likely to be viewed by the user, may be assigned an intermediate urgency value (e.g., to be treated more urgent than portions outside the viewport, but not as urgent as, for example, the location of the football). For example, values for the urgency parameters for the the tiles to be transmitted to the client device may gradually decrease as distance of the tile from the ROI increases. In some embodiments, a number of different qualities for tiles (e.g., indicated in a manifest) may be mapped to the urgency parameters of, e.g., 0-7.

At 1508, the control circuitry of the client device (e.g., 1002 of FIG. 10) may transmit, to the server (e.g., CDN edge 1004 of FIG. 1), an HTTP request requesting each of the regions in the projection map (e.g., a cube projection map, discussed in relation to FIG. 8A-8B) with their respective video qualities. Upon receiving such data from the client, the server may, at 1510, transmit each region to the client device based on the requested quality. In some embodiments, the server may cause the transmittal of the spherical media content to be split into different streams, where L4S (or another suitable technique for preferential treatment of network traffic) may be enabled for stream(s) corresponding to portion(s) associated with lower urgency values (indicating more urgent treatment), and not enabled for stream(s) corresponding to portion(s) associated with higher urgency values (indicating less urgent treatment). In some embodiments, portions of the content corresponding to tiles associated with urgency values less than or equal to a threshold may be preferentially processed using the first queue for preferential network traffic, whereas portions of the content corresponding to tiles associated with urgency values greater than the threshold may be preferentially processed using the second queue for preferential network traffic.

In some embodiments, networking equipment (e.g., LAN networking equipment 1415 of FIG. 14 and/or WAN networking equipment 1417 of FIG. 14) may be used at least in part for any of the steps of FIG. 15. For example, WAN networking equipment 1417 may be used (e.g., based on instructions received from the server, e.g., server 1404 of FIG. 14) to cause designated tiles to be transmitted in a preferential manner or non-preferential manner. For example, the server and/or such networking equipment may perform L4S enablement on a packet by marking the ECN bits in the packet UP header. ECT (1) marking indicates that the sender is capable of L4S transport. If a network element experiences congestion, it converts the 2-bit ECN marking from ECT (1) to CE. The markings are echoed back to the sender in acknowledgements from the receiver. The sender then reduces throughput in scalable manner.

In some embodiments, if there is a change in network conditions, or if a user is determined to be interested in a different region (e.g., a user wearing an HMD move their head), the control circuitry may select, for tiles in the updated viewport or likely to be focused on in the updated viewport, the highest video quality, and thus lowest urgency level (and thus processed preferentially).

The processes discussed above are intended to be illustrative and not limiting. One skilled in the art would appreciate that the steps of the processes discussed herein may be omitted, modified, combined and/or rearranged, and any additional steps may be performed without departing from the scope of the invention. More generally, the above disclosure is meant to be illustrative and not limiting. Only the claims that follow are meant to set bounds as to what the present invention includes. Furthermore, it should be noted that the features described in any one embodiment may be applied to any other embodiment herein, and flowcharts or examples relating to one embodiment may be combined with any other embodiment in a suitable manner, done in different orders, or done in parallel. In addition, the systems and methods described herein may be performed in real time. It should also be noted that the systems and/or methods described above may be applied to, or used in accordance with, other systems and/or methods.

1. A computer-implemented method, comprising:
receiving, from a computing device and over a network, a request to access a spherical media content comprising a plurality of tiles;
determining one or more portions of the spherical media content likely to be included in a viewport associated with the computing device;
determining, based at least in part on the determined one or more portions of the spherical media content likely to be included in the viewport, a plurality of video qualities for the plurality of tiles, wherein one or more tiles of the plurality of tiles corresponding to the one or more portions of the spherical media content likely to be included in the viewport are selected to be provided to the computing device in higher video qualities of the plurality of video qualities than tiles of the plurality of tiles not likely to be included in the viewport;
based at least in part on the plurality of video qualities, identifying a plurality of urgency parameters for the plurality of tiles; and
based at least in part on the identified plurality of urgency parameters, transmitting the plurality of tiles over the network to the computing device.

2. The computer-implemented method of claim 1,
wherein networking equipment associated with the network provides a first queue for preferential network traffic and a second queue for non-preferential network traffic; and
wherein transmitting the plurality of tiles over the network to the computing device based at least in part on the identified plurality of urgency parameters comprises transmitting a first subset of the plurality of tiles using the first queue and transmitting a second subset of the plurality of tiles using the second queue.

3. The computer-implemented method of claim 2, wherein the first subset of the plurality of tiles are transmitted using the first queue based at least in part on having urgency parameter values that exceed a threshold value, and the second subset of the plurality of tiles are transmitted using the second queue based at least in part on having urgency parameter values that do not exceed the threshold value.

4. The computer-implemented method of claim 2, wherein the first subset of the plurality of tiles are transmitted prior to transmitting the second subset of the plurality of tiles.

5. The computer-implemented method of claim 1, wherein the method further comprises:
for each respective urgency level of the plurality of urgency levels:
determine whether tiles of the respective urgency level are associated with an incremental parameter;
transmit tiles of the respective urgency level associated with the incremental parameter serially in their entirety; and
transmit tiles of the respective urgency level not associated with the incremental parameter in parallel.

6. The computer-implemented method of claim 1, wherein a manifest is provided to the computing device, and the plurality of video qualities and the plurality of urgency parameters are determined based on one or more indications received from the computing device, wherein the computing device uses the manifest to identify the plurality of video qualities.

7. The computer-implemented method of claim 1, wherein the plurality of video qualities comprises a plurality of bitrates and resolutions, and the plurality of video qualities are determined based at least in part on current network conditions of the network.

8. The computer-implemented method of claim 1, wherein determining the one or more tiles of the plurality of tiles likely to be included in the viewport associated with the computing device comprises:
determining at least one of a gaze or a head pose of a user of the computing device; and
determining the one or more tiles of the plurality of tiles likely to be included in the viewport associated with the computing device based on determining that the gaze or the head pose of the user corresponds to one or more locations of the one or more tiles.

9. The computer-implemented method of claim 8,
wherein the computing device determines, for each respective tile of the plurality of tiles, an indication of a likelihood that the gaze or the head pose of the user will correspond to the location of the respective tile, wherein the plurality of video qualities are indicated on a manifest provided to the computing device, and wherein a video quality of the plurality of video qualities that each respective tile is to be provided to the computing device in is based on its corresponding determined likelihood; and
wherein identifying the plurality of urgency parameters for the plurality of tiles is based on receiving indications of the plurality of urgency parameters from the computing device, wherein the computing device assigns the plurality of urgency parameters for the plurality of tiles based on the plurality of video qualities.

10. The computer-implemented method of claim 1, wherein the plurality of urgency parameters are HTTP urgency parameters for retrieving an HTML document or an XML document.

11. The computer-implemented method of claim 1, wherein a server determines the one or more portions of the spherical media content likely to be included in the viewport, the plurality of video qualities for the plurality of tiles, and the plurality of urgency parameters for the plurality of tiles, based at least in part on one or more indications received from the computing device.

12. A system, comprising:
control circuitry configured to:
receive, from a computing device and over a network, a request to access a spherical media content comprising a plurality of tiles;
determine one or more portions of the spherical media content likely to be included in a viewport associated with the computing device;
determine, based at least in part on the determined one or more portions of the spherical media content likely to be included in the viewport, a plurality of video qualities for the plurality of tiles, wherein one or more tiles of the plurality of tiles corresponding to the one or more portions of the spherical media content likely to be included in the viewport are selected to be provided to the computing device in higher video qualities of the plurality of video qualities than tiles of the plurality of tiles not likely to be included in the viewport;
based at least in part on the plurality of video qualities, identify a plurality of urgency parameters for the plurality of tiles; and
based at least in part on the identified plurality of urgency parameters, transmit the plurality of tiles over the network to the computing device.

13. The system of claim 12,
wherein networking equipment associated with the network provides a first queue for preferential network traffic and a second queue for non-preferential network traffic; and
wherein the control circuitry is configured to transmit the plurality of tiles over the network to the computing device based at least in part on the identified plurality of urgency parameters by transmitting a first subset of the plurality of tiles using the first queue and transmitting a second subset of the plurality of tiles using the second queue.

14. The system of claim 13, wherein the control circuitry is configured to transmit the first subset of the plurality of tiles using the first queue based at least in part on having urgency parameter values that exceed a threshold value, and transmit the second subset of the plurality of tiles using the second queue based at least in part on having urgency parameter values that do not exceed the threshold value.

15. The system of claim 13, wherein the control circuitry is configured to transmit the first subset of the plurality of tiles prior to transmitting the second subset of the plurality of tiles.

16. The system of claim 12, wherein the control circuitry is further configured to:
for each respective urgency level of the plurality of urgency levels:
determine whether tiles of the respective urgency level are associated with an incremental parameter;
transmit tiles of the respective urgency level associated with the incremental parameter serially in their entirety; and
transmit tiles of the respective urgency level not associated with the incremental parameter in parallel.

17. The system of claim 12, wherein a manifest is provided to the computing device, and the control circuitry is further configured to determine the plurality of video qualities and the plurality of urgency parameters based on one or more indications received from the computing device, wherein the computing device uses the manifest to identify the plurality of video qualities.

18. The system of claim 12, wherein the plurality of video qualities comprises a plurality of bitrates and resolutions, and the control circuitry is configured to determine the plurality of video qualities based at least in part on current network conditions of the network.

19. The system of claim 12, wherein the control circuitry is further configured to determine the one or more tiles of the plurality of tiles likely to be included in the viewport associated with the computing device by:
determining at least one of a gaze or a head pose of a user of the computing device; and
determining the one or more tiles of the plurality of tiles likely to be included in the viewport associated with the computing device based on determining that the gaze or the head pose of the user corresponds to one or more locations of the one or more tiles.

20. The system of claim 19,
wherein the computing device determines, for each respective tile of the plurality of tiles, an indication of a likelihood that the gaze or the head pose of the user will correspond to the location of the respective tile, wherein the plurality of video qualities are indicated on a manifest provided to the computing device, and wherein a video quality of the plurality of video qualities that each respective tile is to be provided to the computing device in is based on its corresponding determined likelihood; and
wherein the control circuitry is configured to identify the plurality of urgency parameters for the plurality of tiles based on receiving indications of the plurality of urgency parameters from the computing device, wherein the computing device assigns the plurality of urgency parameters for the plurality of tiles based on the plurality of video qualities.

21-55. (canceled)
